(19) United States
(12) Patent Application Publication
(10) Pub. No.: US 2025/0197780 A1
(43) Pub. Date: Jun. 19, 2025

(54) LAUNDRY CARE ADDITIVE PARTICLES

(71) Applicant: The Procter & Gamble Company, Cincinnati, OH (US)

(72) Inventors: Eduard Andres CAICEDO CASSO, Maineville, OH (US); Mattia COLLU, Saint-Gilles (BE); Zoe DYTER, Newcastle upon Tyne (GB); Laura ORLANDINI, Geneva (CH); Johan SMETS, Lubbeek (BE); Cedric Marc TAHON, Gent (BE); Pierre Daniel VERSTRAETE, Woluwe Saint Lambert (BE); Linsheng FENG, Menasha, WI (US); Sonia Marcela MALAGON GOMEZ, Appleton, WI (US); Travis Ian BARDSLEY, Appleton, WI (US); Dominick Joseph VALENTI, Moore, SC (US)

(21) Appl. No.: 18/978,202

(22) Filed: Dec. 12, 2024

Related U.S. Application Data
(60) Provisional application No. 63/609,418, filed on Dec. 13, 2023.

(51) Int. Cl. C11D 3/50; C11D 7/26; C11D 7/32; C11D 17/00

(52) U.S. Cl. CPC C11D 3/505; C11D 7/26; C11D 7/329; C11D 17/0039; C11D 2111/12

(57) ABSTRACT

A composition including a plurality of particles, a process for treating laundry using such particles, and a process of making such particles, wherein the particles include: about 25% to about 99% by weight water-soluble carrier; and a plurality of capsules dispersed in the water-soluble carrier, wherein the capsules comprise a core and a shell surrounding the core and the core includes perfume raw materials; wherein the shell includes a polymeric material that is the reaction product of chitosan derived from an aqueous phase and a cross-linking agent.

### FIELD OF THE INVENTION

Laundry care particles that include a polymeric material that is the reaction product of chitosan derived from an aqueous phase and a cross-linking agent.

### BACKGROUND OF THE INVENTION

Laundry care particles are formulated with perfumed core/shell capsules. Typically, the cores of such capsules include perfume, and the shell often comprises a polymeric material such as an aminoplast, a polyurea, or a polyacrylate, or a naturally-derived material such as gelatine, lysine or chitosan. These capsules are useful in delivering the benefit agent to a target surface, such as a fabric. Then, at various touchpoints, the capsules will release the perfume after manipulation.

One capsule technology is the combination of a reaction product of chitosan and a cross-linking agent, wherein the cross-linking agent comprises an isocyanate component, the isocyanate component comprising a mixture of two or more di- and/or poly-isocyanates, derived from an oil phase, the di- and/or poly-isocyanates each comprising an aromatic moiety. Such capsules can be difficult to include in particulate laundry products due to their lack of durability in some manufacturing processes.

With the above limitations in mind, there is a continuing unaddressed need for particulate laundry products having appropriately durable capsules.

### SUMMARY OF THE INVENTION

A composition comprising a plurality of particles, wherein said particles comprise: about 25% to about 99% by weight water-soluble carrier; and a plurality of capsules dispersed in said water-soluble carrier, wherein said capsules comprise a core and a shell surrounding said core and said core comprises perfume raw materials; wherein said shell comprises from about 90% to 100%, optionally from about 95% to 100%, optionally from about 99% to 100% by weight of the shell of a polymeric material that is the reaction product of chitosan derived from an aqueous phase and a cross-linking agent, wherein the cross-linking agent comprises an isocyanate component, the isocyanate component comprising a mixture of two or more di- and/or poly-isocyanates, derived from an oil phase, the di- and/or poly-isocyanates each comprising an aromatic moiety; and wherein the mixture of di- and/or poly-isocyanates comprising an aromatic moiety comprises at least one alpha-aromatic isocyanate and at least one beta-aromatic isocyanate, optionally, wherein the required isocyanates are each present in at least 20 mole percent of the total isocyanate component.

### BRIEF DESCRIPTION OF THE DRAWINGS

FIG. 1 is a schematic of a pastillation apparatus for making particles.

FIG. 2: Perfume Loss after making of Laundry care particles comprising capsules made with different ratios of Alpha-aromatic isocyanates and Beta-aromatic isocyanates.

FIG. 3: Free Oil after SprayDrying capsules made with different ratios of Alpha-aromatic isocyanates and Beta-aromatic isocyanates and varying Shell (%) and Volume Weighted Median Microcapsule Size (um).

### DETAILED DESCRIPTION OF THE INVENTION

The present disclosure relates to laundry care additive particles that include a water-soluble carrier and a plurality of perfume containing capsules dispersed in the carrier, wherein said capsules comprise a core and a shell surrounding said core and said core comprises perfume raw materials; wherein said shell comprises from about 90% to 100%, optionally from about 95% to 100%, optionally from about 99% to 100% by weight of the shell of a polymeric material that is the reaction product of chitosan derived from an aqueous phase, and a cross-linking agent, wherein the cross-linking agent comprises an isocyanate component, the isocyanate component comprising a mixture of two or more di- and/or poly-isocyanates, derived from an oil phase, the di- and/or poly-isocyanates each comprising an aromatic moiety; and, wherein the mixture of di- and/or poly-isocyanates comprising an aromatic moiety comprises at least one alpha-aromatic isocyanate and at least one beta-aromatic isocyanate, optionally, wherein the required isocyanates are each present in at least 20 mole percent of the total isocyanate component.

The laundry care additive particles can be practical for providing benefits to laundry through the wash. That is, the particles can be employed by the user by dispensing the particles into the washing machine prior to starting the washing machine cycle, particularly the wash sub-cycle. Through the wash compositions, such as those described herein, differ from through the rinse compositions. Through the rinse compositions are designed to be dispensed during the rinse sub-cycle of the washing machine. In modern washing machines, the rinse sub-cycle is initiated automatically after the wash sub-cycle is completed, without any further input from the consumer. Compositions that are to be dispensed during the rinse sub-cycle are commonly dosed to a separate dosing chamber that is part of the washing machine that dispenses the through the rinse composition during the rinse sub-cycle, for example a dispensing drawer or from that agitator in the tub.

It is believed that capsules of the type disclosed herein when used in water-soluble carrier work surprisingly well in providing improved consumer acceptable freshness benefits on fabrics.

The terms “substantially free of” or “substantially free from” may be used herein. This means that the indicated material is at the very minimum not deliberately added to the composition to form part of it, or, optionally, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

As described herein, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Water-Soluble Carrier

The particle of the present invention may comprise 25% to 99% by weight of a water-soluble carrier. While any suitable material may be utilized as the water-soluble carrier, one preferred composition comprises polyalkylene glycol.

Polyalkylene glycol water-soluble carrier can be materials selected from polyethylene glycol, polypropethylene glycol, ethylene oxide/propylene oxide block copolymers, and combinations thereof. For example, the water-soluble carrier can be polyethylene glycol (PEG). PEG has a relatively low cost, may be formed into many different shapes and sizes, minimizes free perfume diffusion, and dissolves well in water. The term “polyethylene glycol” or “PEG” as used herein includes homopolymers containing repeating units of ethylene oxide, random copolymers containing repeating units of ethylene oxide and propylene oxide, block copolymers containing blocks of polyethylene oxide and polypropylene oxide, and combinations thereof.

The particles can comprise about 25% to about 99% by weight of the particles of PEG. Optionally, the particles can comprise from about 35% to about 99%, optionally from about 40% to about 99%, optionally from about 50% to about 99%, optionally combinations thereof and any whole percentages or ranges of whole percentages within any of the aforementioned ranges, of PEG by weight of the respective particles. Preferably, the PEG present in the particles is characterized by a weight average molecular weight (Mw) ranging from about 2,000 to about 20,000 Daltons, optionally from about 2,000 to about 15,000 Da, alternatively from about 4,000 to about 20,000 Da, alternatively from about 4,000 to about 15,000 Da, alternatively from about 4,000 to about 12,000 Da, alternatively from about 5,000 to about 11,000 Da, alternatively from about 6,000 to about 10,000 Da, alternatively from about 7,000 to about 9,000 Da, alternatively combinations thereof. Suitable PEGs include homopolymers commercially available from BASF under the tradenames of Pluriol® E 8000.

While combinations of molecular weight PEG may be utilized, it is believed that PEG having a molecular weight below 4,000 Da, should have a relatively low level of weight percentage use as compared to the PEG having a molecular weight above that of 4,000 Da. It is believed that PEG having a molecular weight below 4,000 Da, has a lower melt temperature and can introduce processing difficulties. To offset this lower melt temperature of the lower molecular weight PEG, higher molecular weight PEG may be utilized at a higher weight percentage than that of the lower molecular weight PEG. For example, the higher molecular weight PEG may be introduced at a ratio of at least about 1.1:1.

Alternatively, the polyalkylene glycol water-soluble carrier can be an ethylene oxide-propylene oxide-ethylene oxide (EOx₁POyEOx₂) triblock copolymer, which preferably has an average ethylene oxide chain length of between about 2 and about 90, preferably about 3 and about 50, more preferably between about 4 and about 20 ethylene oxide units, and an average propylene oxide chain length of between 20 and 70, preferably between 30 and 60, more preferably between 45 and 55 propylene oxide units. More preferably, the ethylene oxide-propylene oxide-ethylene oxide (EOx₁POyEOx₂) triblock copolymer has a molecular weight of from about 2,000 to about 30,000 Daltons, preferably from about 3,000 to about 20,000 Daltons, more preferably from about 4,000 to about 15,000 Daltons.

Preferably, the copolymer comprises between 10% and 90%, preferably between 15% and 50%, most preferably between 15% and 25% by weight of the copolymer of the combined ethylene-oxide blocks. Most preferably the total ethylene oxide content is equally split over the two ethylene oxide blocks. Equally split herein means each ethylene oxide block comprising on average between 40% and 60% preferably between 45% and 55%, even more preferably between 48% and 52%, most preferably 50% of the total number of ethylene oxide units, the % of both ethylene oxide blocks adding up to 100%. Some ethylene oxide-propylene oxide-ethylene oxide (EOx₁POyEOx₂) triblock copolymer improve cleaning.

Suitable ethylene oxide-propylene oxide-ethylene oxide triblock copolymers are commercially available under the Pluronic series from the BASF company, or under the Tergitol L series from the Dow Chemical Company. A particularly suitable material is Pluronic® PE 9200. Other suitable materials include Pluronic® F38, F68 and F108.

The polyalkylene glycol water-soluble carrier also included “end capped” polyalkylene glycol. Typically, polyalkylene glycol has two —OH groups at both ends of the polymer chain, “end capped” means at least one or both of the —OH groups are reacted and connected to end capping organic group different from the polyalkylene glycol. Preferably, the end capping organic group R connected to the —OH groups of the polyalkylene glycol via an ether bond (—O—R) and/or ester bond (—O—(C═O)—R), where R is a linear or branched C₁-C₃₀ alkyl group, a cycloalkyl group with 5 to 9 carbon atoms, a C₆-C₃₀ arylalkyl group, a C₆-C₃₀ alkylaryl group. More preferably, R is a linear or branched C₁-C₃₀ alkyl group, even more preferably a linear C₁-C₆ alkyl group and even more preferably a methyl (CH₃).

Examples of suitable “end capped” polyalkylene glycol include a polyethylene glycol fatty alcohol ether of formula:

H₃C—(CH₂)ₜ—O—[CH₂—CH₂—O]_{q}—(CH₂)ₜ—CH₃
wherein
q is based on a molar average, a number from 30 to 250.
t is based on a molar average, a number from 0 to 30.

Examples of suitable “end capped” polyalkylene glycol include a polyethylene glycol fatty alcohol esters of formula:

H₃C—(CH₂)ₜ—(C═O)—O—[CH₂—CH₂—O]_{q}—(C═O)—(CH₂)ᵣ—CH₃
wherein
q is based on a molar average, a number from 30 to 250.
t is based on a molar average, a number from 0 to 30.

Additional options for polyalkylene glycol include modified polyalkylene glycol having a formula of:

HO—(C₂H₄O)ₛ—(CH₂)ₜ)—CH₃;
wherein
s is based on a molar average, a number from 63-68
t is based on a molar average, a number from 13 to 19, preferably 17.

Carrier compositions comprising the above formulation may comprise from about 10 wt. % to about 60 wt. % of the above modified polyalkylene glycol, preferably from about 20 wt. % to about 50 wt. %, even more preferably from about 25 wt. % to about 45 wt. %, and most preferably from about 30 wt. % to about 40 wt. %.

### Other Water-Soluble Carriers

The water-soluble carrier can be a material that is soluble in a wash liquor within a short period of time, for instance less than about 10 minutes.

The particle may further comprise other water-soluble carriers selected from inorganic alkali metal salt, inorganic alkaline earth metal salt, organic alkali metal salt, organic alkaline earth metal salt, carbohydrates and derivatives thereof, clay, zeolites, silica, silicates, citric acid and salts thereof, fatty alcohol, glycerol, glyceryl diester of hydrogenated tallow, water-soluble polymers, and combinations thereof.

Suitable inorganic alkali metal salts can be selected from the group consisting of sodium fluoride, sodium chloride, sodium bromide, sodium iodide, sodium sulfate, sodium bisulfate, sodium phosphate, sodium monohydrogen phosphate, sodium dihydrogen phosphate, sodium carbonate, sodium hydrogen carbonate, sodium silicate, potassium fluoride, potassium chloride, potassium bromide, potassium iodide, potassium sulfate, potassium bisulfate, potassium phosphate, potassium monohydrogen phosphate, potassium dihydrogen phosphate, potassium carbonate, potassium monohydrogen carbonate, potassium silicate, and combinations thereof.

Suitable inorganic alkaline earth metal salts can be selected from the group consisting of magnesium fluoride, magnesium chloride, magnesium bromide, magnesium iodide, magnesium sulfate, magnesium phosphate, magnesium monohydrogen phosphate, magnesium dihydrogen phosphate, magnesium carbonate, magnesium monohydrogen carbonate, magnesium silicate, calcium fluoride, calcium chloride, calcium bromide, calcium iodide, calcium sulfate, calcium phosphate, calcium monohydrogen phosphate, calcium dihydrogen phosphate, calcium carbonate, calcium monohydrogen carbonate, calcium silicate, and combinations thereof.

Organic salts, such as organic alkali metal salts and organic alkaline earth metal salts, contain carbon.

Suitable organic alkali metal salts can be selected from the group consisting of sodium acetate, sodium citrate, sodium lactate, sodium tartrate, sodium ascorbate, sodium sorbate, potassium acetate, potassium citrate, potassium lactate, potassium tartrate, potassium ascorbate, potassium sorbate, and combinations thereof.

Suitable organic alkali metal salts can be selected from the group consisting of calcium acetate, calcium citrate, calcium lactate, calcium tartrate, calcium ascorbate, calcium sorbate, magnesium acetate, magnesium citrate, magnesium lactate, magnesium tartrate, magnesium ascorbate, magnesium sorbate, and combinations thereof.

Carbohydrates may be selected from the group consisting of monosaccharides, disaccharides, oligosaccharides, polysaccharides and derivatives thereof, and combinations thereof.

Suitable monosaccharides may be selected from the group consisting of erythrose, ribose, arabinose, xylose, glucose, isoglucose, dextrose, galactose, mannose, erythrulose, ribulose, fructose, sorbose, rhamnose, fucose, deoxyribose, ribose, and combinations thereof.

Suitable disaccharides sugar may be selected from the group consisting of sucrose, maltose, lactose, isomaltose, trehalose, cellobiose, melibiose, gentiobiose, and combinations thereof.

Suitable oligosaccharides may be selected from the group consisting of maltotriose, raffinose, stachyose, and combinations thereof.

Preferably the sugar is selected from the group consisting of fructose, glucose, isoglucose, galactose, raffinose, and combinations thereof. More preferably the sugar comprises or is sucrose.

Suitable polysaccharides may be selected from the group consisting of starch, corn starch, wheat starch, rice starch, potato starch, tapioca starch, modified starch, cellulose, carboxymethyl cellulose, methyl cellulose, ethyl cellulose, propyl cellulose, hydroxyethyl cellulose, hydroxypropyl cellulose, cellulose esters, cellulose amides, glycogen, pectin, dextrin, maltodextrin, corn syrup solids, alginates, xyloglugans, xylan, glucuronoxylan, arabinoxylan, mannan, dextran, glucomannan, galactoglucomannan, xanthan, carrageenan, locust bean gum, Arabic gum, tragacanth, and combinations thereof.

Carbohydrate derivatives may be selected from the group consisting of aminosugars, deoxysugars, sugar alcohols, sugar acids, and combinations thereof.

Suitable sugar alcohol may be selected from the group consisting of sorbitol, mannitol, isomalt, maltitol, lactitol, xylitol, erythritol, and combinations thereof. Preferably the sugar alcohol is selected from the group consisting of mannitol, sorbitol, xylitol and combinations thereof. Sugar alcohol polyols are described in additional detail in U.S. Ser. No. 11/920,111.

The water-soluble carrier may be selected from the group consisting of clay, zeolites, citric acid and salts thereof, fatty alcohol, glyceryl diester of hydrogenated tallow, and combinations thereof.

The water-soluble carrier may be a water-soluble polymer selected from the group consisting of polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyglycerol esters, acrylamide; polyvinyl acetates; polycarboxylic acids and salts thereof, sulfonated polyacrylates, polyaminoacids or peptides, polyamides, polyacrylamide, copolymers of maleic/acrylic acids, gelatin, and combinations thereof.

Some specific examples of suitable carrier materials can include combinations of the foregoing. For example, a carrier material may comprise a mixture of a first wt. % of polyethylene glycol; a second wt. % of sodium bicarbonate; a third wt. % of sodium acetate trihydrate. In such configurations, the first wt. % may be from about 30 to about 70, more preferably from about 40 to about 60, even more preferably from about 45 to about 58, or most preferably from about 52 to about 56.

The second wt. % may be from about 10 to about 30, more preferably from about 15 to about 25, even more preferably from about 15 to about 20. It is worth noting that where higher percentages of sodium bicarbonate are utilized, dissolution problems can occur. For example, where hard water is utilized as part of the wash process, it is believed that a portion of the sodium carbonate may react with the hard water and form calcium carbonate. As the calcium carbonate may not dissolve entirely in the wash process, pieces of calcium carbonate may appear on clothes which can give consumers a negative impression of the performance of the particle.

The third wt. % may be from about 10 to about 30, more preferably from about 15 to about 25, even more preferably from about 15 to about 20. It is worth noting that where higher percentages of sodium acetate are utilized, discoloring as well as generation of odor can occur. It is believed that the sodium acetate can degrade and form acetic acid. The acetic acid can cause discoloration of the particles as well as a vinegary smell for the particles. This can cause consumers to have a very negative impression of the performance of the particles, particularly where the particles are advertised to provide a great smelling fragrance to articles of laundry.

As another example, the carrier material may comprise polyethylene glycol, block copolymer of ethylene oxide and propylene oxide and clay, e.g. bentonite and/or other organic clay materials.

As another example, the carrier material may comprise sodium chloride, propylene glycol, and sodium starch octenylsuccinate.

As another example, the carrier material may comprise sodium acetate, dipropylene glycol, cellulose, sodium hydroxide, and sodium acrylate copolymer.

As yet another example, the carrier material may comprise a modified polyethylene glycol as described herein along with polyethylene glycol. The modified polyethylene glycol may have a higher molecular weight than the polyethylene glycol. Additionally, the modified polyethylene glycol may be present at a higher weight percentage than the polyethylene glycol.

As yet another example, the carrier material may comprise from about 45% to about 80%, preferably about 50% to about 70%, preferably about 50% to about 60%, by weight sugar alcohol polyol selected from the group consisting of or selected from or selected from at least one of erythritol, xylitol, mannitol, isomalt, maltitol, lactitol, trehalose, lactose, tagatose, sucralose, and mixtures thereof.

### Fragrance/Perfume

The particles of the present disclosure may comprise one or more fragrances/perfumes. At least a portion of the fragrances/perfumes may be provided in a plurality of capsules as described herein. Similarly, at least a portion of the fragrances/perfumes may be comprised by the carrier outside of the capsules. Regardless of whether the fragrance/perfume is comprised by the carrier or by the capsules the fragrance/perfume may be configured similarly. It is worth noting that while the fragrance/perfume comprised by the carrier and the fragrance/perfume comprised by the plurality of capsules may be similarly configured, they may have difference scents or different intensities. Configurations of the fragrances/perfumes suitable for use with the particles of the present disclosure is provided in additional detail herein.

### Capsules

The compositions of the present disclosure further include a plurality of capsules. As described in more detail below, the capsules may include a core surrounded by a shell wherein the shell comprises a polymeric material that is the reaction product of chitosan, and a cross-linking agent, wherein the cross-linking agent comprises an isocyanate component, the isocyanate component comprising a mixture of two or more di- and/or poly-isocyanates, the di- and/or poly-isocyanates each comprising an aromatic moiety; and, wherein the mixture of di- and/or poly-isocyanates comprising an aromatic moiety comprises at least one alpha-aromatic isocyanate and at least one beta-aromatic isocyanate, optionally, wherein the required isocyanates are each present in at least 20 mole percent of the total isocyanate component.

The capsules may be present in the particles of the composition in an amount that is from about 0.1% to about 20%, or from about 0.2% to about 10%, or from about 0.2% to about 5%, or from about 0.2% to about 3%, by weight of the composition. The composition may comprise a sufficient amount of capsules to provide from about 0.1% to about 20%, or from about 0.2% to about 10%, or from about 0.2% to about 5%, by weight of the composition, of perfume raw materials to the composition. When discussing herein the amount or weight percentage of the capsules, it is meant the sum of the shell material and the core material.

For capsules containing a core material to perform and be cost effective in consumer good applications, such as laundry care particle additives, they should: i) be resistant to core diffusion during the shelf life of the liquid product (e.g., low leakage or permeability); ii) have ability to deposit on the targeted surface during application (e.g. washing machine cycle) and iii) be able to release the core material by mechanical shell rupture at the right time and place to provide the intended benefit for the end consumer.

i. Core

The capsules include a core. The core may comprise a liquid or a solid. Preferably, the core comprises a liquid which may be oil-based or aqueous. Preferably the core comprises a liquid at room temperature in the finished product.

The liquid includes perfume. The liquid may comprise from about 1 wt % to 100 wt % perfume, based on the total weight of the liquid in the core. Optionally, the liquid can include 50 wt % to 100 wt % perfume based on the total weight of the core, optionally 80 wt % to 100 wt % perfume based on the total weight of the core. Typically, higher levels of perfume are preferred for improved delivery efficiency.

The perfume may comprise one or more, optionally two or more, perfume raw materials. The term “perfume raw material” (or “PRM”) as used herein refers to compounds having a molecular weight of at least about 100 g/mol and which are useful in imparting an odor, fragrance, essence, or scent, either alone or with other PRMs. Typical PRMs comprise inter alia alcohols, ketones, aldehydes, esters, ethers, nitriles and alkenes, such as terpenes. A listing of common PRMs can be found in various reference sources, for example, “Perfume and Flavor Chemicals”, Vols. I and II; Steffen Arctander Allured Pub. Co. (1994) and “Perfumes: Art, Science and Technology”, Miller, P. M. and Lamparsky, D., Blackie Academic and Professional (1994).

The PRMs may be characterized by their boiling points (B.P.) measured at the normal pressure (760 mm Hg), and their octanol/water partition coefficient (P), which may be described in terms of log P, determined according to the test method described in Test methods section. Based on these characteristics, the PRMs may be categorized as Quadrant I, Quadrant II, Quadrant III, or Quadrant IV PRMs, as described in more detail below. A perfume having a variety of PRMs from different quadrants may be desirable, for example, to provide fragrance benefits at different touchpoints during normal usage.

PRMs having a boiling point B.P. lower than about 250° C. and a log P lower than about 3 are known as Quadrant I PRMs. Quadrant 1 PRMs are optionally limited to less than 30% of the perfume composition. PRMs having a B.P. of greater than about 250° C. and a log P of greater than about 3 are known as Quadrant IV PRMs, PRMs having a B.P. of greater than about 250° C. and a log P lower than about 3 are known as Quadrant II PRMs, PRMs having a B.P. lower than about 250° C. and a log P greater than about 3 are known as a Quadrant III PRMs. Suitable Quadrant I, II, III and IV PRMs are disclosed in U.S. Pat. No. 6,869,923 B1.

The perfume may comprise a mixture of at least 3, or even at least 5, or at least 7 PRMs. The perfume may comprise at least 10 or at least 15 PRMs. A mixture of PRMs may provide more complex and desirable aroma, and/or better perfume performance or longevity, for example at a variety of touchpoints. However, it may be desirable to limit the number of PRMs in the perfume to reduce or limit formulation complexity and/or cost.

The perfume may comprise at least one perfume raw material that is naturally derived, e.g., of plant origin. Such components may be desirable for sustainability/environmental reasons. Naturally derived PRMs may include natural extracts or essences, which may contain a mixture of PRMs. Such natural extracts or essences may include orange oil, lemon oil, rose extract, lavender, musk, patchouli, balsamic essence, sandalwood oil, pine oil, cedar, and the like. The PRMs may be selected from the group of almond oil, ambrette, angelica seeds oil, armoise oil, basil oil grand vert, benzoin resinoid, bergamot essential oil, bergamot oil, black pepper oil, black pepper essence, black currant essence, blood orange oil, bois des landes, brandy pure jungle essence, cade, camomille romaine he, cardamom guat extract, cardamom oil, carrot heart, caryophyllene extra, cedar, cedarleaf, cedarwood oil, cinnamon bark ceylon, cinnamon ceylan extract, beeswax, citronella, citronellal, clary sage essential oil, clove leaf oil rectified, copaiba balsam, coriander, cos cos anethol, cos cos essence coriandre russie, cucumber extract, cumin oil, cypriol heart, elemi coeur, elemi oil, english white camomile, eucalyptol, Eucalyptus citriodora, eugenol, galbanum heart, ginger, grapefruit replacer, guaiacwood oil, gurjum oil, healingwood blo, helichrysum, iso eugenol, jasmine sambac, juniper berry oil, key lime, labdanum resinoid, lavandin abrialis oil, lavandin grosso, lavender essential oil, lemon cedrat, lemon oil, lemon peel verdelli, lemongrass, lemongrass oil, Litsea cubeba, magnolia flower oil, mandarin oil yellow, menthol cristalisé, mint piperita cascade, narcisse, neroli oil, nutmeg, orange flower water, orange oil, orange phase oil, organic rose water, osmanthus, patchouli, patchouli heart, patchouli oil, pepper black oil, peppermint, peru balsam absolute, petitgrain t'less, pimento berry oil, pink pepper, raspberry essence, rhodinol, rose, rose centifolia, sandalwood, sichuan pepper extract, styrax white, sweet orange oil, tangerine oil, vanilla, vetiver, violet leaves, violette feuilles, wormwood oil, and combinations thereof.

The core may comprise, in addition to PRMs, a pro-perfume, which can contribute to improved longevity of freshness benefits. Pro-perfumes may comprise nonvolatile materials that release or convert to a perfume material as a result of, e.g., simple hydrolysis, or may be pH-change-triggered pro-perfumes (e.g. triggered by a pH drop) or may be enzymatically releasable pro-perfumes, or light-triggered pro-perfumes or oxidation-triggered pro-perfumes. The pro-perfumes may exhibit varying release rates depending upon the pro-perfume chosen.

The core of the encapsulates of the present disclosure may comprise a core modifier, such as a partitioning modifier and/or a density modifier. The core may comprise, in addition to the perfume, from greater than 0% to 80%, optionally from greater than 0% to 50%, optionally from greater than 0% to 30% based on total core weight, of a core modifier. The partitioning modifier may comprise a material selected from the group of vegetable oil, modified vegetable oil, mono-, di-, and tri-esters of C₄-C₂₄ fatty acids, isopropyl myristate, dodecanophenone, lauryl laurate, methyl behenate, methyl laurate, methyl palmitate, methyl stearate, and mixtures thereof. The partitioning modifier may optionally comprise or consist of isopropyl myristate. The modified vegetable oil may be esterified and/or brominated. The modified vegetable oil may optionally comprise castor oil and/or soybean oil. US Patent Application Publication 20110268802, incorporated herein by reference, describes other partitioning modifiers that may be useful in the presently described perfume encapsulates.

ii. Shell

The capsules of the present disclosure include a shell that surrounds the core. The shell can include or be a polymeric material comprising the reaction product of a cross-linking agent from an oil phase, and a chitosan derived from a water phase. The cross-linking agent comprises a mixture of two or more di- and/or poly-isocyanates, derived from the oil phase, the di- and/or poly-isocyanates each containing an aromatic moiety. Surprisingly, it has been found that leakage can be controlled as a function of two isocyanates, each comprising at least one aromatic moiety, which when combined with chitosan yield low leakage capsules in different matrices and carriers, to an extent heretofore unachieved with degradable constructs. More particularly the cross-linking agent comprises an isocyanate component, wherein the isocyanate component comprises a mixture of two or more di- and/or poly-isocyanates, derived from an oil phase, the di- and/or poly-isocyanates each comprising an aromatic moiety; and each isocyanate is independently selected from the group of an alpha-aromatic isocyanate and a beta-aromatic isocyanate. In embodiments, the mixture of di- and/or poly-isocyanates can comprise at least one alpha isocyanate and at least one beta isocyanate.

Enhanced performance in terms of lower leakage and retention of core material in carrier material is surprisingly obtainable wherein the weighted % NCO of the aromatic isocyanate of the isocyanate component is from 15 to 32% or even from 20 to 26%, or even from 20 to 25% by weight, or even from 21 to 25% by weight. The mass percent of the alpha-aromatic isocyanate in the isocyanate component can be from 1 to 99% by weight, optionally from 5 to 90% by weight, optionally from 30 to 60% by weight. The mass percent of the beta-aromatic isocyanate in the isocyanate component is from 1% to 99% by weight, optionally from 5% to 10% by weight, optionally from 70% to 40% by weight. The isocyanate component has a ratio of alpha-aromatic isocyanate to beta-aromatic isocyanate in the range from 20 to 50% by weight, optionally from 25 to 40% by weight, optionally from 30 to 35% by weight.

In addition to the composition, also disclosed is a method of making the composition which is a population of core-shell capsules. The core comprises a benefit agent, and the shell comprises a polymeric material that is the reaction product of a cross-linking agent of at least two isocyanate monomers, oligomers, or prepolymers, and the chitosan, The method of making the capsules comprises the steps of:
forming a water phase dissolving or dispersing chitosan in water. Optionally, prior to capsule shell formation, the chitosan can be pretreated with one or more of a redox initiator such as a persulfate or with an acid or acids at a pH of from pH 3 to pH 6.5, or even a pH of from 4 to 6.5 at a temperature of at least 25° C., for at least one hour or to achieve a viscosity of less than 1500 centipoise (cp) and optionally less than 500 cp, to form a treated chitosan; and,
forming an oil phase comprising dissolving together at least one benefit agent and an isocyanate component comprising at least two isocyanates having an aromatic moiety wherein the weighted % NCO of the aromatic isocyanate of the isocyanate component is from 15 to 32% or even from 20 to 26%, or even from 20 to 25% by weight, or even from 21 to 25% by weight; and,
forming an emulsion by mixing under high shear agitation the water phase and the oil phase into an excess of the water phase, thereby forming droplets of the oil phase dispersed in the water phase, and optionally adjusting the pH of the emulsion to be in a range from pH 3 to pH 6; and,
curing the emulsion by heating to at least 40° C., for a time sufficient to form a shell at an interface of the droplets with the water phase, the shell comprising the reaction product of the cross-linking component and the chitosan, and the shell surrounding the core comprising the droplets of the oil phase. Optionally the chitosan can be a treated chitosan. The droplets of the oil phase comprise the benefit agent in that the benefit agent is itself an oil or soluble in an added oil or soluble in the cross-linking agent.

In some specific examples, at least 21 wt % of the shell comprises chitosan. In embodiments, the isocyanate component comprises methylenediphenyl isocyanate and xylylene diisocyanate in a weight ratio of from 1:2 to 1:1.75. In embodiments, the isocyanate component comprises by weight 30 to 40% methylenediphenyl isocyanate and from 60 to 70% xylylene diisocyanate.

The capsules can comprise a core material and a shell encapsulating the core material. The core material can comprise a benefit agent. The shell comprises a polymeric material that is the reaction product of chitosan derived from an aqueous phase, and a cross-linking agent comprising an isocyanate component comprising a mixture of two or more di- and/or poly-isocyanates, derived from an oil phase, the di- and/or poly-isocyanates each comprising an aromatic moiety. The isocyanates are di-isocyanates, tri-isocyanates or a mixture of di- and tri-isocyanates.

Controlling leakage into matrices and carriers in the presence of water is challenging. Shelf stability of products in terms of low leakage into the carrier or matrix in the presence of water is important in maintaining the ability to deliver benefit agents such as fragrances at desired touch points. Benefit agent prematurely leaked into matrices or carrier is less available at desired later touchpoints. Encapsulation is used to retain the benefit agent for increased product shelf life. In certain articles of manufacture, such as treatment compositions for fabrics and textiles, it is desirable to retain the benefit agent for expression at later stage touch points such as after the wash, in the dry cycle, or during wearing. Leaked benefit agent is generally not available for desired expression at such later stages, though such expression is highly sought after, yet difficult to achieve successfully. Surprisingly, it has been found that leakage can be controlled as a function of two isocyanates each comprising an aromatic moiety, which when combined with chitosan yield a low leakage capsule in different matrices and carriers, to an extent heretofore unachieved with degradable constructs.

Low leakage can be achieved with careful selection of a mixture of di- and/or poly-isocyanates, comprising alpha or beta isocyanates, especially those combinations comprising at least one alpha isocyanate and at least one beta isocyanate. In embodiments, surprisingly low leakage into carrier material is seen when the weighted % NCO of the aromatic isocyanate of the isocyanate component is from 15 to 32% or even from 20 to 26%, or even from 20 to 25% by weight, or even from 21 to 25% by weight. In particular the compositions can comprise an isocyanate component comprising an alpha and/or beta-aromatic isocyanate. The alpha-aromatic isocyanate is selected from the group of:

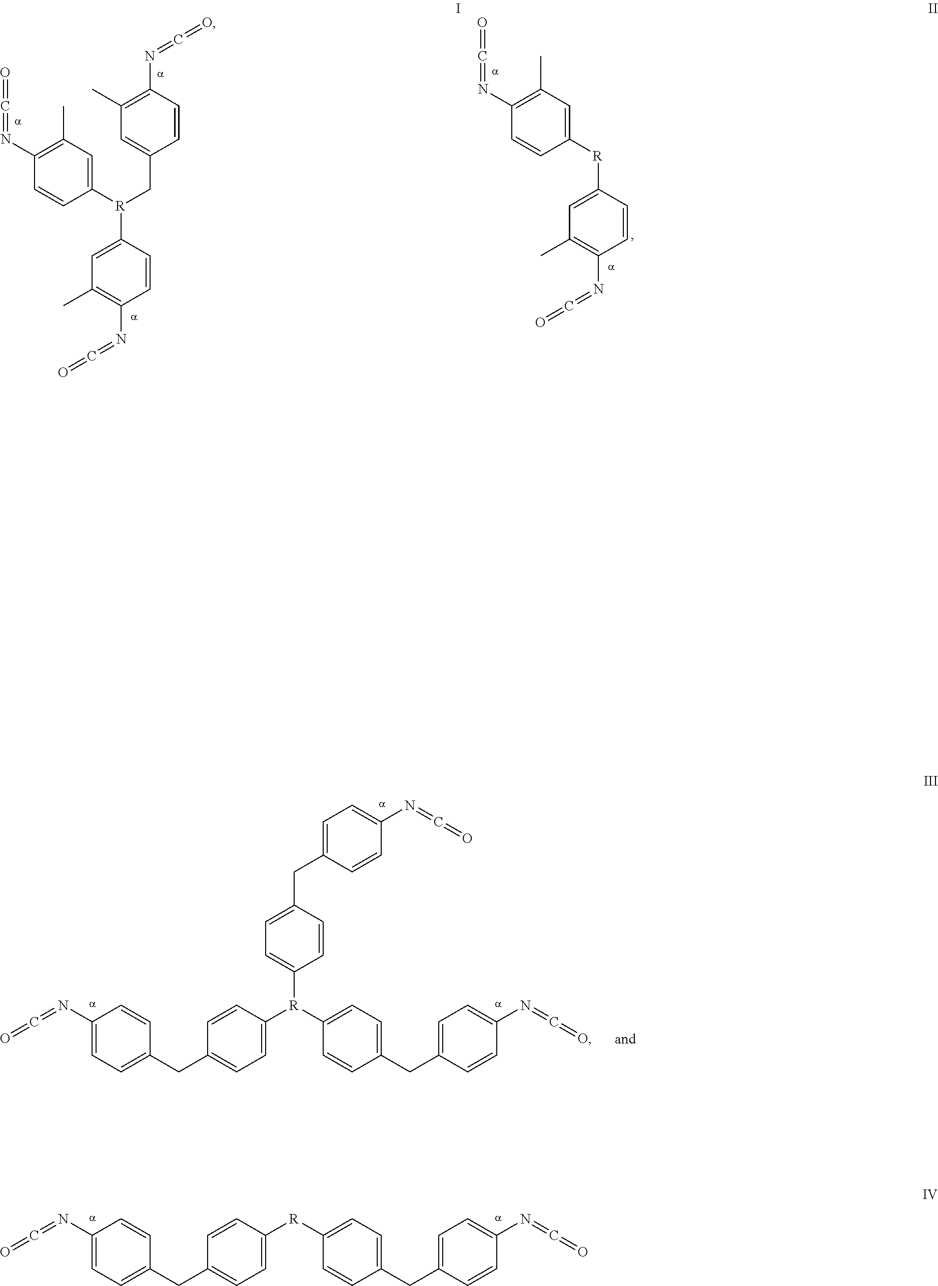

wherein R is a biuret, a uretdione, an isocyanurate, a polyol having a pendant urethane group, a polyamine having a urea pendant group, a polyacid with an anhydride group, a poly-isocyanate comprising a biuret, a poly-isocyanate comprising a uretdione, or a polyisocyanate comprising an isocyanurate.

R in structures I, II, III and IV and XII and XIII for example comprises moieties with at least two or more functional groups that link into the respective di- or tri-isocyanate. R in structures I, II, III and IV and XII and XIII for example can comprise polyol, or a polyol having one or more pendant urethane groups, or a polyamine, such as a polyamine having one or more urea pendant groups or other linking groups, a polyacid with an anhydrate group, a poly-isocyanate comprising a biuret, a poly-isocyanate comprising a uretdione, or a polyisocyanate comprising an isocyanurate. In structures I, II, III and IV and XII and XIII for example the R moieties include at least two or more functional groups that link into the respective di- or tri-isocyanate.

The aromatic isocyanates of formulas I-XVI are based on derivative variations of generally commercially available isocyanates such as xylylene diisocyanate (XDI), toluene diisocyanate (TDI) and methylene diphenyl diisocyanates (MDI).

The above selected aromatic isocyanates are generally available commercially. For example, Covestro in Leverkusen, Germany is a supplier of polyisocyanates and prepolymers under the Desmodur brand. Polyisocyanates conforming to the structures I-XVI disclosed herein are available under the Desmodur E brand of isocyanates and prepolymers, and/or can also be derived synthetically. Optionally aromatic isocyanates are also commercially available from sources such as Mitsui Chemicals, Inc., Tokyo, Japan such as the Takenate brand of isocyanates, e.g., Takenate D-110N adducts based on xylylene diisocyanate.

Specific examples of alpha-aromatic isocyanates that may be useful can be selected from the group of:

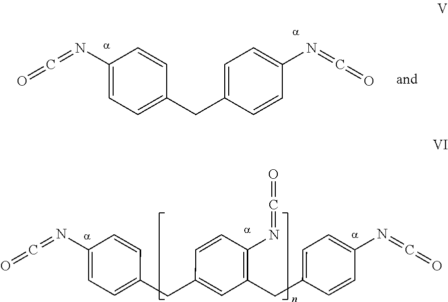

wherein n is an integer from 1 to 24, optionally from 1 to 18, or even from 1 to 12, or even from 1 to 8,

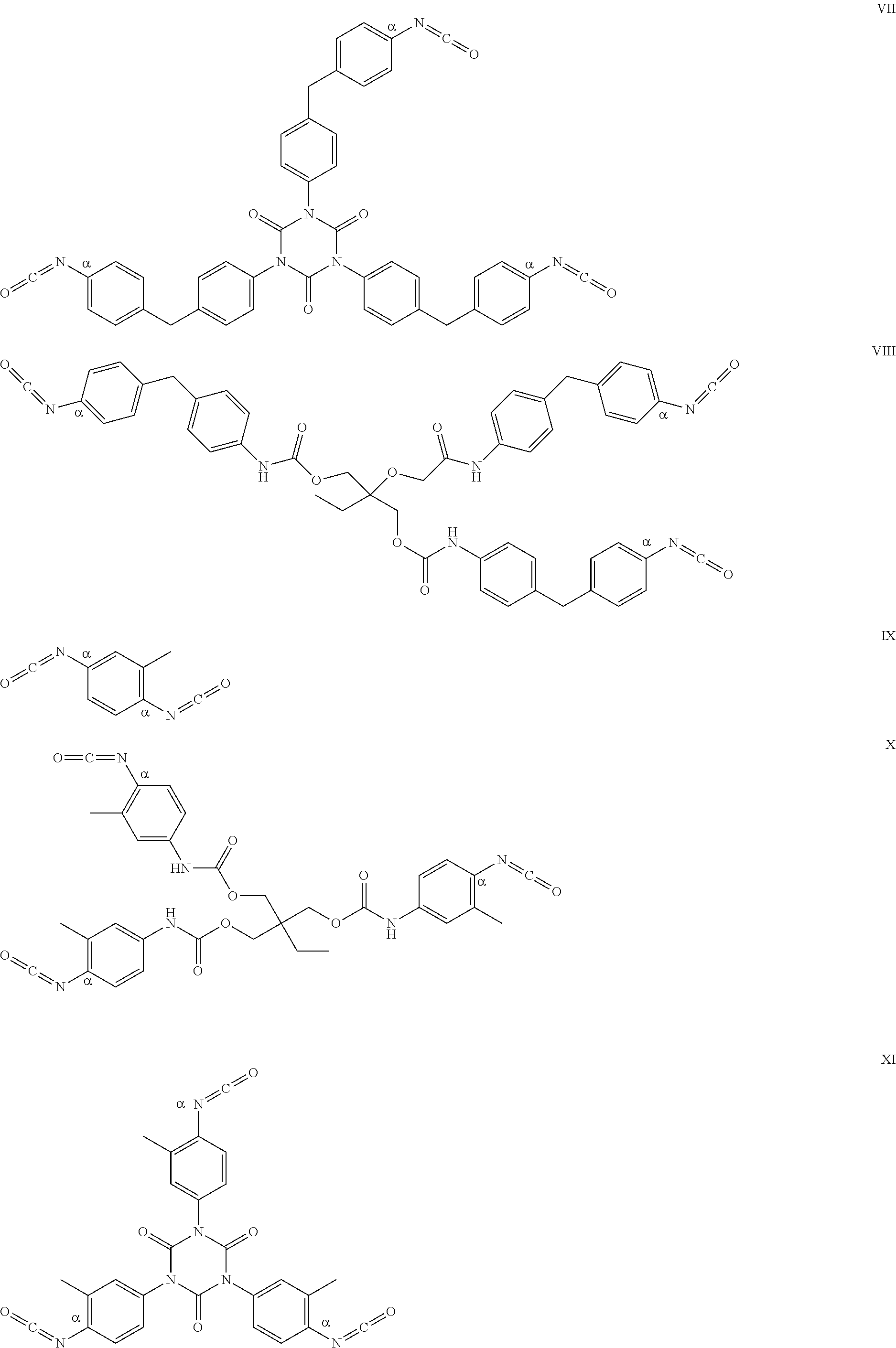

The beta-aromatic isocyanate that can be useful can be selected from the group of:

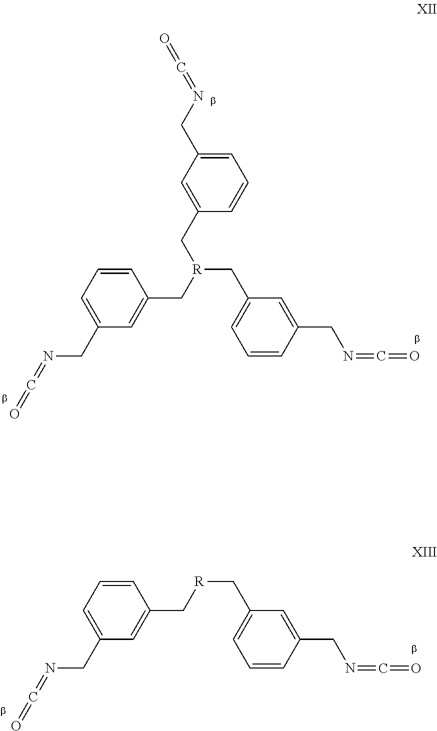

wherein R is a polyol having a pendant urethane group, a polyamine having a urea pendant group, a polyacid with an anhydrate group, a poly-isocyanate comprising a biuret, a poly-isocyanate comprising a uretdione, a polyisocyanate comprising an isocyanurate.

The alpha-aromatic isocyanate can also be selected from the group of toluene diisocyanate, methylene diphenyl diisocyanate, polymeric methylene diphenyl diisocyanate, naphthalene diisocyanate, phenylene diisocyanate, isomers thereof, adducts thereof, and combinations thereof, and optionally selected from methylene diphenyl diisocyanate, polymeric methylene diphenyl diisocyanate, isomers thereof, adducts thereof, and combinations thereof. Specific examples of beta-aromatic isocyanates that can be useful can be selected from the group of:

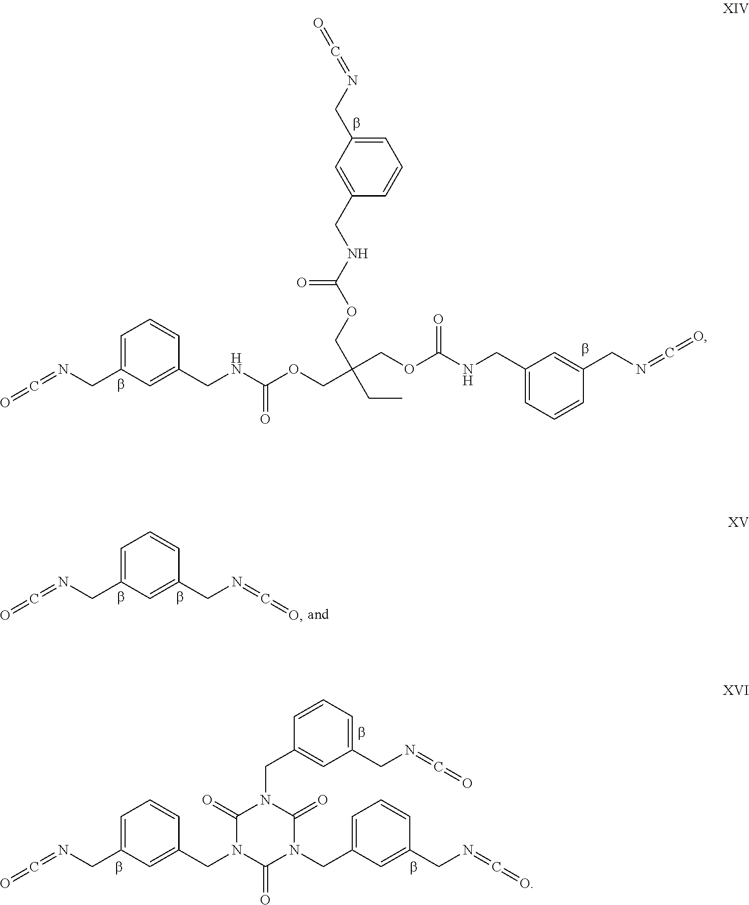 [SMILES: CCC(COC(=O)NCc1cccc(CN=C=O)c1)(COC(=O)NCc1cccc(CN=C=O)c1)COC(=O)NCc1cccc(CN=C=O)c1 ; O=C=NCc1cccc(CN=C=O)c1 ; O=C=NCc1cccc(Cn2c(=O)n(Cc3cccc(CN=C=O)c3)c(=O)n(Cc3cccc(CN=C=O)c3)c2=O)c1]

The beta-aromatic isocyanate can also be selected from the group of xylylene diisocyanate, trimethylolpropane adducts of xylylene diisocyanate, tetramethylxylidene diisocyanate, isomers thereof, adducts thereof, and combinations thereof.

The present disclosure relates to treatment compositions that include capsules having shells made, at least in part, from chitosan-based materials. In particular, the capsules include a shell comprising a reaction product of chitosan and a cross-linking agent. The cross-linking agent comprises an isocyanate component comprising a mixture of two or more di- and/or poly-isocyanates, derived from an oil phase, the di- and/or poly-isocyanates each containing an aromatic moiety. The isocyanate component can comprise at least two di- and/or poly-isocyanates selected from methylene diphenyl diisocyanate and xylylene diisocyanate. In embodiments, the xylylene diisocyanate comprises a trimethylol propane-adduct of xylylene diisocyanate. the methylene diphenyl diisocyanate can be selected from 2,2′-methylenediphenyl diisocyanate and 4,4′-methylenediphenyl diisocyanate. Optionally the isocyanate components are in a weight ratio of from 1:2 to 1:1.75. Desirably the isocyanate component comprises by weight 30 to 40% of a methylene diphenyl diisocyanate and from 60 to 70% of a xylylene diisocyanate. Usefully, the isocyanate component comprises by weight about 34% methylene diphenyl diisocyanate and about 66% xylylene diisocyanate. Chitosan in combination with the isocyanate component within this isocyanate range or ratio surprisingly is able to efficiently deliver benefit agent at desired touchpoints. Leakage into matrix components and/or carriers is surprisingly reduced as a function of the combination with two isocyanates with the chitosan. The mixture of isocyanates having an aromatic moiety for example can comprise for example trimers of xylylene diisocyanate (XDI) or oligomers or pre-polymers of methylene diphenyl diisocyanate (MDI).

Optionally, prior to shell formation, the chitosan used to make the particle shells can be treated such with acid, or even a mixture of acids such as describe in U.S. Ser. 63/429,232 filed Dec. 1, 2022, or with a redox initiator optionally persulfate such as described in U.S. Ser. 63/429,240 filed Dec. 1, 2022, incorporated herein by reference. The redox initiator is selected from any of persulfate or a peroxide. Optionally, the redox initiator is selected from the group of ammonium persulfate, sodium persulfate, potassium persulfate, cesium persulfate, benzoyl peroxide, hydrogen peroxide, and mixtures thereof.

Typically, when chitosan is dissolved in water, for example during the process of making capsules, the resulting mixture tends to be quite viscous. This can result in flowability and processing challenges, and/or inhibit the adequate formation of capsules shells. It has been described in U.S. Ser. No. 63/429,232 that acid treatment can result in a decrease of the mixture's viscosity and an improved shell structure. Additionally, it is believed that acid treating the chitosan can beneficially affect the molecular weight of the chitosan, thereby leading to improved shell formation and/or delivery performance.

The capsules have shells made, at least in part, from chitosan-based materials. In particular, the capsules include a shell comprising a reaction product of chitosan and the isocyanate component.

Without wishing to be bound by theory, it is believed that careful selection of the chitosan and isocyanate combination within the weight ratios disclosed can be advantageous in surprisingly achieving a long shelf-life composition containing capsules. For example, selection of an isocyanate component as disclosed can result in capsules that perform better at certain touchpoints. It is believed that the combination of isocyanates as disclosed yields to higher density capsules. It is believed that the surprising effect of reduced leakage is attributable to not only density of the polymeric material but also related to the presence of aromatic moieties in combination with the reactive sites of the isocyanate component.

Furthermore, chitosan tends to present processing challenges, particularly its viscosity, in aqueous environments. The viscosity can affect the flowability of solutions and/or inhibit the adequate formation of particle walls. Optionally treatment with acid can aid in lowering of the solution viscosity. Without wishing to be bound by theory, it is believed that careful selection of the chitosan's molecular weight can be advantageous. For example, selection of a chitosan having a molecular weight above a certain threshold can result in capsules that perform better at certain touchpoints compared to particles made from chitosan of a lower molecular weight. Surprisingly treatment with acid can yield a chitosan at a 3.5% concentration, typically having a starting viscosity or approximately 4000 cP, displaying a viscosity reduction of 60% or even exceeding 60%, to a viscosity of 1500 cP, or even 1000 cP at the same concentration as compared to an untreated chitosan.

A composition comprising a core-shell encapsulate, also known as a capsule, including a process of making such encapsulates or capsules is disclosed. The core comprises a benefit agent, optionally a perfume, and the shell can comprise for example a polyurea resin polymeric material which is the reaction product of a cross-linking agent comprising a mixture of two or more di- and/or poly-isocyanates derived from an oil phase the di- and/or poly-isocyanates each comprising an aromatic moiety. In forming the composition, chitosan dissolved or dispersed in an aqueous phase and optionally treated with an acid, optionally at a pH of from 3 to about 6.5. The chitosan is treated with acid at a pH of 6.5 or less, or even less than pH 6.0, or even at a pH of from 3 to 6, or even at a pH of 3.5 to 6, or even at a pH of 4 to 6, and a temperature of at least 25° C. for at least one hour. Typically, this treatment step is measurable as a period to obtain a chitosan solution having a viscosity of 1500 centipoise, or less than 1500 centipoise (cp) and optionally less than 500 cp.

The chitosan is characterized by a weight average molecular weight of from about 100 to about 80,000 kDa, or even from 100 kDa to about 600 kDa. Optionally, the chitosan is characterized by a weight average molecular weight (Mw) of from about 100 kDa to about 500 kDa, optionally from about 100 kDa to about 400 kDa, optionally from about 100 kDa to about 300 kDa, optionally from about 100 kDa to about 200 kDa. The method used to determine the chitosan's molecular weight and related parameters is provided in the Test Methods section below and uses gel permeation chromatograph with multi-angle light scatter and refractive index detection (GPC-MALS/RI) techniques. Selecting chitosan having the preferred weight average molecular weight can result in capsules having suitable shell formation and/or desirable processibility. For clarity the chitosan weight average molecular weight is measured prior to treatment, such as with acid and/or redox initiator as herein described.

The ratio of the isocyanate component cross-linking agent to chitosan, based on weight, is 79:21 to 10:90, or even 2:1 to 1:10, or even 1:1 to 1:7.

The cross-linking agent of the composition optionally can comprise additional polyisocyanate to the mixture of two or more di- or poly-isocyanates. The additional cross-linking agent can be an aliphatic or aromatic monomer, oligomer or prepolymer, usefully of two or more isocyanate functional groups Additional crosslinking agents of the isocyanate type, for example, can be selected from aromatic toluene diisocyanate and its derivatives used in wall formation for capsules, or aliphatic monomer, oligomer or prepolymer, for example, hexamethylene diisocyanate and dimers or trimers thereof, or 3,3,5-trimethyl-5-isocyanatomethyl-1-isocyanato cyclohexane tetramethylene diisocyanate, polyisocyanurate of toluene diisocyanate, a trimethylol propane adduct of toluene diisocyanate, toluene diisocyanate, tetramethylxylidene diisocyanate, naphthalene-1,5-diisocyanate, phenylene diisocyanate, 1,3-diisocyanato-2-methylbenzene, hydrogenated MDI, bis(4-isocyanatocyclohexyl) methane, dicyclohexylmethane-4,4′-diisocyanate, and oligomers and prepolymers thereof. The additional isocyanates that can be useful comprise isocyanate monomers, oligomers or prepolymers, or dimers or trimers thereof, having at least two isocyanate groups. Optimal cross-linking can be achieved with isocyanates having at least three functional groups. This listing is illustrative and not intended to be limiting. Additional crosslinking agents of the isocyanate type can be formed from adducts of polyisocyanates. An adduct is the product of a molecule with itself and/or with another molecule. In the case of adducts of polyisocyanates with themselves, the isocyanate moieties of the polyisocyanate molecule can react with each other, forming a larger polyisocyanate product containing biuret, uretdione, and/or isocyanurate moieties. In the case of polyol adducts of polyisocyanates, the isocyanate moieties of the polyisocyanate molecule can react with the hydroxyl moieties of a polyol, forming a larger polyisocyanate product containing urethane moieties. In the case of polyamine adducts of polyisocyanates, the isocyanate moieties of the polyisocyanate molecule can react with the amine moieties of a polyamine, forming a larger polyisocyanate product containing urea moieties. In the case of polyacid adducts of polyisocyanates, the isocyanate moieties of the polyisocyanate molecule can react with the carboxylic moieties of a polyacid, forming a larger polyisocyanate product containing anhydride moieties. Where a polyisocyanate is a molecule containing 2 or more isocyanate moieties.

When formulated as described herein, the shell degrades at least 40% or even at least 60% of its mass after at least 60 days when tested according to test method OECD 301B.

The core-shell encapsulate has a ratio of core to shell of at least 75:25, or 85:15, or 90:10, or even up to 99:1, or even at least 99.5:0.5, on the basis of weight. The shell can comprise 1 to 25 percent by weight of the core-shell encapsulate.

To create the capsules as described herein, a water phase is prepared, comprising a water solution or dispersion of an amine-containing natural material having free amino moieties. The amine containing natural material is a bio-based material. Such materials for example include chitosan. The amine-containing natural material is dispersed in water. In the case of chitosan, the material, in embodiments, can even be hydrolyzed thereby protonating at least a portion of the amine groups and facilitating dissolving in water. Hydrolysis is carried out with heating for a period at an acidic pH such as about 3 to about 6.5, or even about 5 or 5.5.

The oil phase is prepared by dissolving the isocyanate component in oil at 25° C. Diluents, for example isopropyl myristate, may be used to adjust the hydrophilicity of the oil phase. The oil phase is then added into the water phase and milled at high speed to obtain a targeted size. The emulsion is then cured in one or more heating steps, such as heating to 40° C. in 30 minutes and holding at 40° C. for 60 minutes. Times and temperatures are approximate. The temperature and time are selected to be sufficient to form and cure a shell at the interface of the droplets of the oil phase with the water continuous phase. For example, the emulsion is heated to 85° C. in 60 minutes and then held at 85° C. for 360 minutes to cure the capsules. The slurry is then cooled to room temperature.

Volume weighted median particle size of capsules can range from 5 microns to 150 microns, or even from 10 to 50 microns, optionally 15 to 50 microns.

The cross-linking agent can be a mixture or bi- or poly-functional isocyanates. When referring to useful cross-linking agents reference to polyisocyanate should be understood for purposes hereof as inclusive of isocyanate monomer, isocyanate oligomer, isocyanate prepolymer, or dimer or trimer of an aliphatic or aromatic isocyanate. All such monomers, prepolymers, oligomers, or dimers or trimers of aliphatic or aromatic isocyanates are intended by the term “polyisocyanate” as used herein.

The capsule shell could also be reinforced using additional co-crosslinkers such as multifunctional amines and/or polyamines such as diethylene triamine (DETA), polyethylene imine, and polyvinyl amine.

The shell may also be reinforced using additional co-crosslinkers such as multifunctional amines and/or polyamines, such as diethylene triamine (DETA), polyethylene imine, polyvinyl amine, or mixtures thereof. Acrylates may also be used as additional co-crosslinkers, for example to reinforce the shell.

The polymeric material may be formed in a reaction, where the weight ratio of the chitosan present in the reaction to the cross-linker present in the reaction is from about 1:10 to about 1:0.1. It is believed that selecting desirable ratios of the biopolymer to the cross-linking agent can provide desired ductility benefits, as well as improved biodegradability. It may be preferred that at least 21 wt % of the shell is comprised of moieties derived from chitosan, optionally from acid-treated chitosan. Chitosan as a percentage by weight of the shell may be from about 21% up to about 95% of the shell. The ratio of chitosan in the water phase as compared to the isocyanate in the oil phase may be, based on weight, from 21:79 to 90:10, or even from 1:2 to 10:1, or even from 1:1 to 7:1. The shell may comprise chitosan at a level of 21 wt % or even greater, optionally from about 21 wt % to about 90 wt %, or even from 21 wt % to 85 wt %, or even 21 wt % to 75 wt %, or 21 wt % to 55 wt % of the total shell being chitosan. The chitosan of this paragraph may optionally be acid-treated chitosan or treated with a redox initiator such as persulfate or both.

Chitosan may be added into water in a jacketed reactor and optionally pre-treated with one or both of redox initiator or at a pH from 3 to 6.5, adjusted using an acid (such as one or more of HCl, formic acid or acetic acid). The optional pretreatment step can be accomplished by heating to elevated temperature, such as 85° C. in 60 minutes, and then holding at this temperature from 1 minute to 1440 minutes or longer. The water phase then may be cooled to 25° C. Optionally, a deacetylating step may be added to further facilitate or enhance depolymerization or deacetylation of the chitosan such as by enzymes. An oil phase is prepared by dissolving a mixture of isocyanates, comprising an aromatic moiety, in oil at 25° C. Diluents, for example isopropyl myristate, may be used to adjust the hydrophobicity of the oil phase. The oil phase may then be added into the water phase and milled at high speed to obtain a targeted size. The emulsion may then be cured in one or more heating steps, such as heating to 40° C. in 30 minutes and holding at 40° C. for 60 minutes. Times and temperatures are approximate. The temperature and time are selected to be sufficient to form and cure a shell at the interface of the droplets of the oil phase with the water continuous phase. For example, the emulsion may be heated to 85° C. in 60 minutes and then held at 85° C. for 360 minutes to cure the particles. The slurry may then be cooled to room temperature.

The shell may degrade at least 50% after 20 days (or less) when tested according to test method OECD 301B. The shell may degrade at least 60% of its mass after 60 days (or less) when tested according to test method OECD 301B. The shell may optionally degrade at least 60% of its mass after 60 days (or less) when tested according to test method OECD 301B. The shell may degrade from 30-100%, optionally 40-100%, 50-100%, 60-100%, or 60-95%, in 60 days, optionally 50 days, optionally 40 days, optionally 28 days, optionally 14 days.

### Process for Treating Laundry

The process for treating laundry can comprise the steps of: providing an article of laundry in a washing machine; dispensing the composition comprising a plurality of particles into the washing machine; and contacting the article of laundry during a wash sub-cycle of the washing machine with the composition. The washing machine can have a wash sub-cycle and rinse sub-cycle. About 5 g to about 50 g of the composition of particles can be dispensed into the washing machine.

By providing scent benefit through the wash sub-cycle, consumers only need to dose the detergent composition and the composition comprising a plurality of particles to a single location, for example the wash basin, prior to or shortly after the start of the washing machine. This can be more convenient to consumers than using rinse added composition that is separately dispensed into the wash basin after the wash sub-cycle is completed, for example prior to, during, or in between rinse cycles. It can be inconvenient to use auto-dispensing features of modern upright and high efficiency machines since that requires dispensing the rinse added composition to a location other than where detergent composition is dispensed.

Optionally, the process can further comprise the step of contacting the article of clothing during the wash sub-cycle of the washing machine with a detergent composition comprising from about 3% to about 60%, optionally about 3% to about 40%, by weight anionic surfactant. The anionic surfactant can be selected from a sulphate, a sulphonate, a carboxylate, and mixture thereof. The detergent composition differs from the particles. The detergent composition can optionally be provided separate from the particles. The detergent composition can be dispensed separate from the composition comprising a plurality of particles.

Washing machines have at least two basic sub-cycles within a cycle of operation: a wash sub-cycle and a rinse sub-cycle. The wash sub-cycle of a washing machine is the cycle on the washing machine that commences upon first filling or partially filing the wash basin with water. A main purpose of the wash sub-cycle is to remove and or loosen soil from the article of clothing and suspend that soil in the wash liquor. Typically, the wash liquor is drained at the end of the wash sub-cycle. The rinse sub-cycle of a washing machine occurs after the wash sub-cycle and has a main purpose of rinsing soil, and optionally some benefit agents provided to the wash sub-cycle from the article of clothing.

The process can optionally comprise a step of contacting the article of clothing during the wash sub-cycle with a detergent composition comprising an anionic surfactant. Most consumers provide a detergent composition to the wash basin during the wash sub-cycle. Detergent compositions can comprise anionic surfactant, and optionally other benefit agents including but not limited to perfume, bleach, brighteners, hueing dye, enzyme, and the like. During the wash sub-cycle, the benefit agents provided with the detergent composition are contacted with or applied to the article of clothing disposed in the wash basin. Typically, the benefit agents of detergent compositions are dispersed in a wash liquor of water and the benefit agents.

During the wash sub-cycle, the wash basin may be filled or at least partially filled with water. The individual particles of the composition can dissolve or disperse into the water to form a wash liquor comprising the components of the particles. Optionally, if a detergent composition is employed, the wash liquor can include the components of the detergent composition and the components of the particles. The plurality of particles can be placed in the wash basin of the washing machine before the article of clothing is placed in the wash basin of the washing machine. The plurality of particles can be placed in the wash basin of the washing machine after the article of clothing is placed in the wash basin of the washing machine. The plurality of particles can be placed in the wash basin prior to filling or partially filling the wash basin with water or after filling of the wash basin with water has commenced.

If a detergent composition is employed by the consumer in practicing the process of treating an article of clothing, the detergent composition and the particles of the composition can be provided from separate packages. For instance, the detergent composition can be a liquid detergent composition provided from a bottle, sachet, water-soluble pouch, dosing cup, dosing ball, or cartridge associated with the washing machine. The particles of the composition can be provided from a separate package, by way of non-limiting example, a carton, bottle, water-soluble pouch, dosing cup, sachet, or the like. If the detergent composition is a solid form, such as a powder, water-soluble fibrous substrate, water-soluble sheet, water-soluble film, water-soluble film, water insoluble fibrous web carrying solid detergent composition, the particles of the composition can be provided with the solid form detergent composition. For instance, the particles of the composition can be provided from a container containing a mixture of the solid detergent composition and the particles of the composition. Optionally, the particles of the composition can be provided from a pouch formed of a detergent composition that is a water-soluble fibrous substrate, water-soluble sheet, water-soluble film, water-soluble film, water insoluble fibrous web carrying solid detergent composition.

### Process for Forming Particles

The particles of the composition can be made by a process comprising multiple steps. The particles can be formed by tableting or melt processing. A melt composition can be prepared comprising about 25% to about 99% by weight water-soluble carrier and about 0.1% to about 20% by weight capsules.

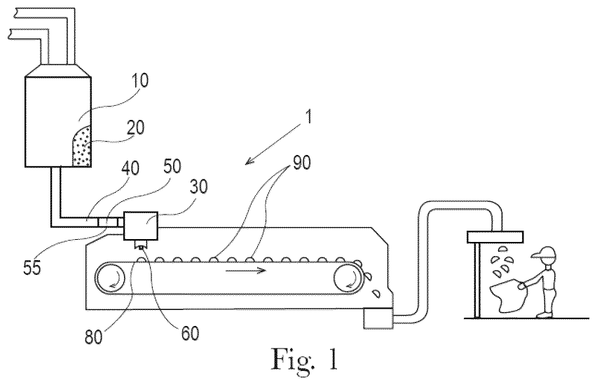

The particles of the composition can be formed by using a particle making apparatus 1 (FIG. 1). A melt composition 20 can be prepared in a batch mixer 10 or continuous mixer 10 or made on a bench top by hand mixing the component materials. When the carrier is a water-soluble polymer, the water-soluble polymer can be heated to a temperature that is above the water-soluble polymer onset of melt and below the flash point or boiling point of the perfume within the capsule.

A melt composition 20 comprising the water-soluble carrier and capsules can be passed through one or more apertures 60 and deposited on a moving conveyor 80 as an extrudate or as droplets. The mixture can optionally be deposited into depressions of a mold and cooled or allowed to cool so that the mixture solidifies into the particles 90. The particles can be removed from the depressions of the mold to yield the finished product. A plurality of apertures can be provided in a distributor 30. The melt composition 20 can be transported to the distributor via a feed pipe 40. Optionally a mixer 50, such as a static mixer 55, can be provided in line with the feed pipe 40. Optionally the feed pipe 40 may be insulated or provided with a heated jacket.

Optionally, the particles 90 can be formed by passing a mixture comprising the water-soluble carrier and capsules through one or more apertures 60 of a distributor and depositing the mixture on a moving conveyor 80 beneath the one or more apertures 60. The mixture may be solidified to form the particles 90. The mixture may be deposited on the moving conveyor 80 as an extrudate and the extrudate can be cut to form the particles 90. Or the mixture can be passed through the one or more apertures 60 to form droplets on the moving conveyor 80 and the droplets can be solidified to form the particles 90.

Optionally, a gas feed line can be included upstream of the distributor 30 to include gas within the melt composition. Downstream of the gas feed line, the melt composition 30 can be milled to break up the gas bubbles so that the melt is a gas entrained melt. The particles formed from a gas entrained melt can include gas bubbles. The gas feed line and mill can be an integrated unit, by way of nonlimiting example an OAKES FOAMER (E.T. Oakes Corporation, 686 Old Willets Path, Hauppauge, NY 11788) 2MT1A continuous foamer. Optionally gas can be entrained into the melt composition 20 by mixing a gas generating material in the melt composition 20.

### Particles

The particles can each have a mass from about 1 mg to about 500 mg, alternatively from about 5 mg to about 500 mg, alternatively from about 5 mg to about 200 mg, alternatively from about 10 mg to about 100 mg, alternatively from about 20 mg to about 50 mg, alternatively from about 35 mg to about 45 mg, alternatively about 38 mg. An individual particle may have a volume from about 0.003 cm³ to about 5 cm³, optionally from about 0.003 cm³ to about 1 cm³, optionally from about 0.003 cm³ to about 0.5 cm³, optionally from about 0.003 cm³ to about 0.2 cm³, optionally from about 0.003 cm³ to about 0.15 cm³. Smaller particles are thought to provide for better packing of the particles in a container and faster dissolution in the wash. The composition can comprise less than 10% by weight of particles having an individual mass less than about 10 mg. This can reduce the potential for dust.

The particles disclosed herein, in any of the embodiments or combination disclosed, can have a shape selected from the group of a sphere, hemisphere, oblate sphere, cylindrical, polyhedral, and oblate hemisphere. The particles may be hemispherical, compressed hemispherical, or have at least one substantially flat or flat surface. Such particles may have relatively high surface area to mass as compared to spherical particles. Dissolution time in water may decrease as a function of increasing surface area, with shorter dissolution time being preferred over longer dissolution time.

The particles disclosed herein can have ratio of maximum dimension to minimum dimension from about 10 to 1, optionally from about 8 to 1, optionally about 5 to 1, optionally about 3 to 1, optionally about 2 to 1. The particles disclosed herein can be shaped such that the particles are not flakes. Particles having a ratio of maximum dimension to minimum dimension greater than about 10 or that are flakes can tend to be fragile such the particles are prone to becoming dusty. The fragility of the particles tends to decrease with decreasing values of the ratio of maximum dimension to minimum dimension.

The particles can comprise less than about 20% by weight anionic surfactant, optionally less than about 10% by weight anionic surfactant, optionally less than about 5% by weight anionic surfactant, optionally less than about 3% by weight anionic surfactant, optionally less than about 1% by weight anionic surfactant. The particles can comprise from 0 to about 20%, optionally from 0 to about 10%, optionally from about 0 to about 5%, optionally from about 0 to about 3%, optionally from about 0 to about 1% by weight anionic surfactant.

The particles can comprise less than about 10% by weight water.

The particles can comprise bubbles of gas. The bubbles of gas can be spherical bubbles of gas. Since the particles can include bubbles of gas entrained therein, the particles can have a density that is less than the density or weighted average density of the constitutive solid and or liquid materials forming the particles. It can be advantageous for particles that include bubbles of gas to include an antioxidant since the bubbles of gas may contribute to oxidation reactions within the particle. Each of the particles can have a density less than about 1 g/cm³. Optionally, the particles can each have a density less than about 0.98 g/cm³. Optionally, the particles can each have a density less than about 0.95 g/cm³. Since the density of a typical washing solution is about 1 g/cm³, it can be desirable to provide particles that each have a density less than about 1 g/cm³ or even less than about 0.95 g/cm³. Particles that individually have a density less than about 1 g/cm³ can be desirable for providing for particles 90 that float in a wash liquor.

Each of the particles can have a volume and the occlusions of gas within the particles 90 can comprise between about 0.5% to about 50% by volume of the particle, or even between about 1% to about 20% by volume of the particle, or even between about 2% to about 15% by volume of the particle, or event between about 4% to about 12% by volume of the particle. Without being bound by theory, it is thought that if the volume of the occlusions of gas is too great, the particles may not be sufficiently strong to be packaged, shipped, stored, and used without breaking apart in an undesirable manner.

The occlusions can have an effective diameter between about 1 micron to about 2000 microns, or even between about 5 microns to about 1000 microns, or even between about 5 microns to about 200 microns, or even between about 25 to about 50 microns. In general, it is thought that smaller occlusions of gas are more desirable than larger occlusions of gas. If the effective diameter of the occlusions of gas are too large, it is thought that the particles might not be sufficiently strong to be to be packaged, shipped, stored, and used without breaking apart in an undesirable manner. The effective diameter is diameter of a sphere having the same volume as the occlusion of gas. The occlusions of gas can be spherical occlusions of gas.

### Packaging

The composition described herein may be provided in any suitable packaging. As an example, plastic bottles may be utilized. In such configurations, preferably plastic can be recycled via a plastics' recycling stream is desired. For example, the container may comprise one or more plastic materials that include polyethylene terephthalate, high density polyethylene, low density polyethylene, polypropylene, or any other plastic which is known in the art and can be recycled.

As the composition described herein comprises a water-soluble carrier, reduced or no interaction with moisture while in storage is useful. Plastic containers can provide a good barrier for moisture and can allow for longevity while in storage. However, where alternatives to plastics are desired, other containers may be utilized as well.

Another suitable container includes a paper-based package. By paper-based material, herein it means a material comprising paper. Without wishing to be bound by theory, by ‘paper’ herein it means a material made from a cellulose-based pulp. Preferably, the paper-based material comprises paper, cardboard, or a mixture thereof, wherein preferably, cardboard comprises paper-board, corrugated fiber-board, or a mixture thereof. The paper-based material may comprise a printed image thereon. Exemplary paper-based packages are described in additional detail below.

The paper-based package may comprise a first part and second part, each comprising an interior surface and an exterior surface, wherein the interior surface faces an internal compartment. The first part and the second part preferably comprise paper-based material. Preferably, the whole of the first part and second part are constructed from a paper-based material.

The paper-based material may be a laminate comprising paper, comprising a first material and a second material. The first material can be cardboard, or a mixture thereof, wherein preferably, the cardboard comprises paper-board, corrugated fiber-board, or a mixture thereof. As noted previously, as the composition of the present disclosure requires reduced and preferably no interaction with moisture, those skilled in the art will be aware of suitable second materials. Preferably, the second material comprises a plastic material. Preferably, the plastic material comprises polyethylene, polyethylene terephthalate, polypropylene, polyvinylalcohol or a mixture thereof. The second material may be a biaxially orientated polypropylene, a metallised polyethylene terephthalate or a mixture thereof. Alternatively, the second material may be a wax, a cellulose material, polyvinylalcohol, or a mixture thereof. It is worth noting that in some configurations, the second material may be discrete from the paper-based material, e.g., an insert into the paper-based material.

The internal surface of the first part and preferably the internal surface of the second part comprises the second material. The external surfaces of the first and second parts may comprise the first material, or vice versa.

Preferably, the paper-based laminate comprises greater than 50%, preferably greater than 85%, and more preferably greater than 95% by weight of the laminate of fiber-based materials. Preferably, the plastic material has a thickness of between 10 micron and 40 micron, more preferably between 10 micron and 35 micron. As noted, the loaded substrates may comprise aqueous hydrogen peroxide. Accordingly, the second material should be selected to minimize the evaporation of the aqueous hydrogen peroxide from the loaded substrates as well as minimize the leakage of the aqueous hydrogen peroxide to the paper-based material to avoid weakening of the overall package.

Paper-based packages are described in U.S. Ser. No. 11/821,142; U.S. Ser. No. 11/913,173; U.S. Ser. No. 11/913,174; and US2022/0033158. The paper-based packages described herein may be recyclable in paper recycling streams which reduces the amount of, and preferably eliminates, material sent to landfill.

As noted, the compositions of the present disclosure may comprise a plurality of particles. The plurality of particles may comprise at least a first set and a second set of particles. The first set and the second set may differ from one another compositionally. For example, the first set may comprise a first dye while the second set comprises a second dye, wherein the first dye and the second dye are different such that the first set of particles and the second set of particles are different colors in the same package. Independently, or in conjunction therewith, the first set of particles may have a first size generally, and the second set of particles may have a second size generally. The first size and the second size may be visibly different such that the user may easily detect the present of both the first set of particles and the second set of particles in a single container.

Additionally, the first set and the second set may comprise compositional differences which either include or do not include the color of the particles. For example, at least one of the first set of particles may comprise a fabric softening active, an enzyme, or other functional ingredient useful for laundry applications which is absent from the second set of particles. Such configurations may also be accommodated with different sized, shaped, and/or colored particles, e.g. first set is visibly distinct from the second set.

### Combinations

Specifically contemplated combinations of the disclosure are herein described in the following lettered paragraphs. These combinations are intended to be illustrative in nature and are not intended to be limiting.
A. A composition comprising a plurality of particles, wherein said particles comprise:
   about 25% to about 99% by weight water-soluble carrier; and
   a plurality of capsules dispersed in said water-soluble carrier, wherein said capsules comprise a core and a shell surrounding said core and said core comprises perfume raw materials;
   wherein said shell comprises from about 90% to 100%, optionally from about 95% to 100%, optionally from about 99% to 100% by weight of the shell of a polymeric material that is the reaction product of chitosan derived from an aqueous phase and a cross-linking agent, wherein the cross-linking agent comprises an isocyanate component, the isocyanate component comprising a mixture of two or more di- and/or poly-isocyanates, derived from an oil phase, the di- and/or poly-isocyanates each comprising an aromatic moiety; and
   wherein the mixture of di- and/or poly-isocyanates comprising an aromatic moiety comprises at least one alpha-aromatic isocyanate and at least one beta-aromatic isocyanate,
   optionally, wherein the required isocyanates are each present in at least 20 mole percent of the total isocyanate component.
B. The composition according to Paragraph A, wherein the weighted % NCO of the di- and/or poly-isocyanates comprising an aromatic moiety within the isocyanate component is from 15 to 32% or even from 20 to 26%, or even from 20 to 25% by weight, or even from 21 to 25% by weight, and wherein:
   the % NCO of Isocyanate compounds is calculated as below Equation:

$$\% NCO = \frac{Number of NCO groups \cdot M W NCO group}{M W Isocyanate compound}$$

where Number of isocyanate groups (NCO groups) is the count of isocyanate groups present in the compound, MW NCO group is the molecular weight of a single NCO group, MW Isocyanate compound is the molecular weight of the entire isocyanate compound, excluding any solvent or other substances that may be mixed with the isocyanate.
C. The composition according to Paragraph A or B, wherein the mass percent of the alpha-aromatic isocyanate in the isocyanate component is from 1 to 99% by weight, optionally from 5 to 90% by weight, optionally from 30 to 60% by weight.
D. The composition according to any of Paragraphs A to C, wherein the mass percent of the alpha-aromatic isocyanate in the isocyanate component is from 1 to 99% by weight, optionally from 5 to 90% by weight, optionally from 30 to 60% by weight.
E. The composition according to any of Paragraphs A to D, wherein the alpha-aromatic isocyanate is selected from the group of:

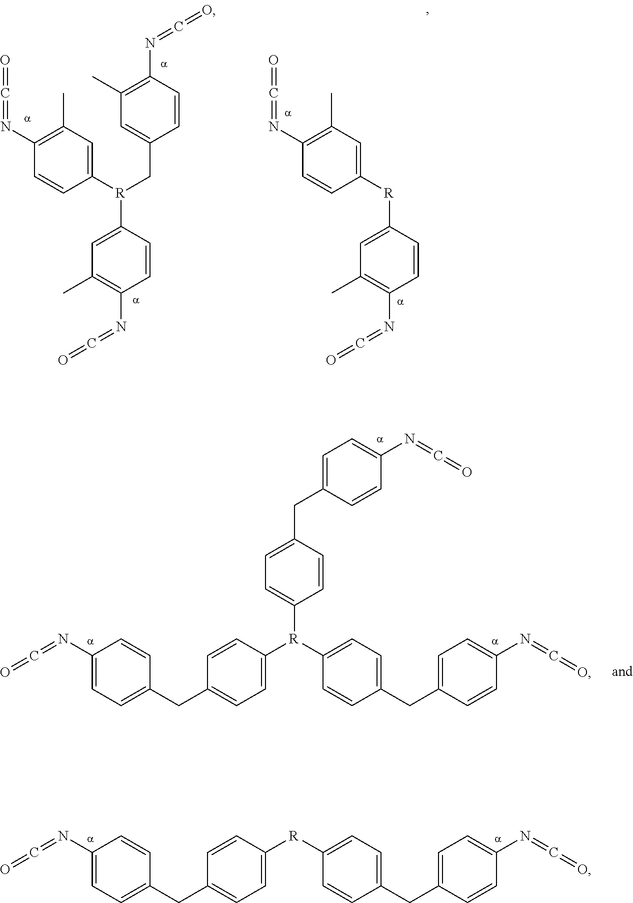

wherein R is a biuret, a uretdione, a isocyanurate, a polyol, a polyol having a urethane group, a urea, a polyamine, a polyamine having a urea group, a polyacid with an anhydride group, a poly-isocyanate comprising a biuret, a poly-isocyanate comprising a uretdione, or a polyisocyanate comprising an isocyanurate,
optionally, wherein the alpha-aromatic isocyanate is selected from the group of:

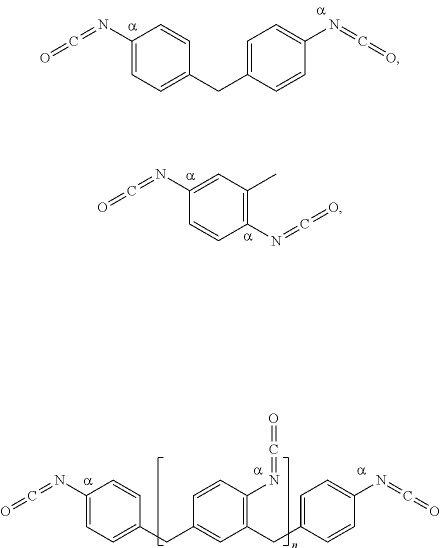

wherein n is an integer from 1 to 24,

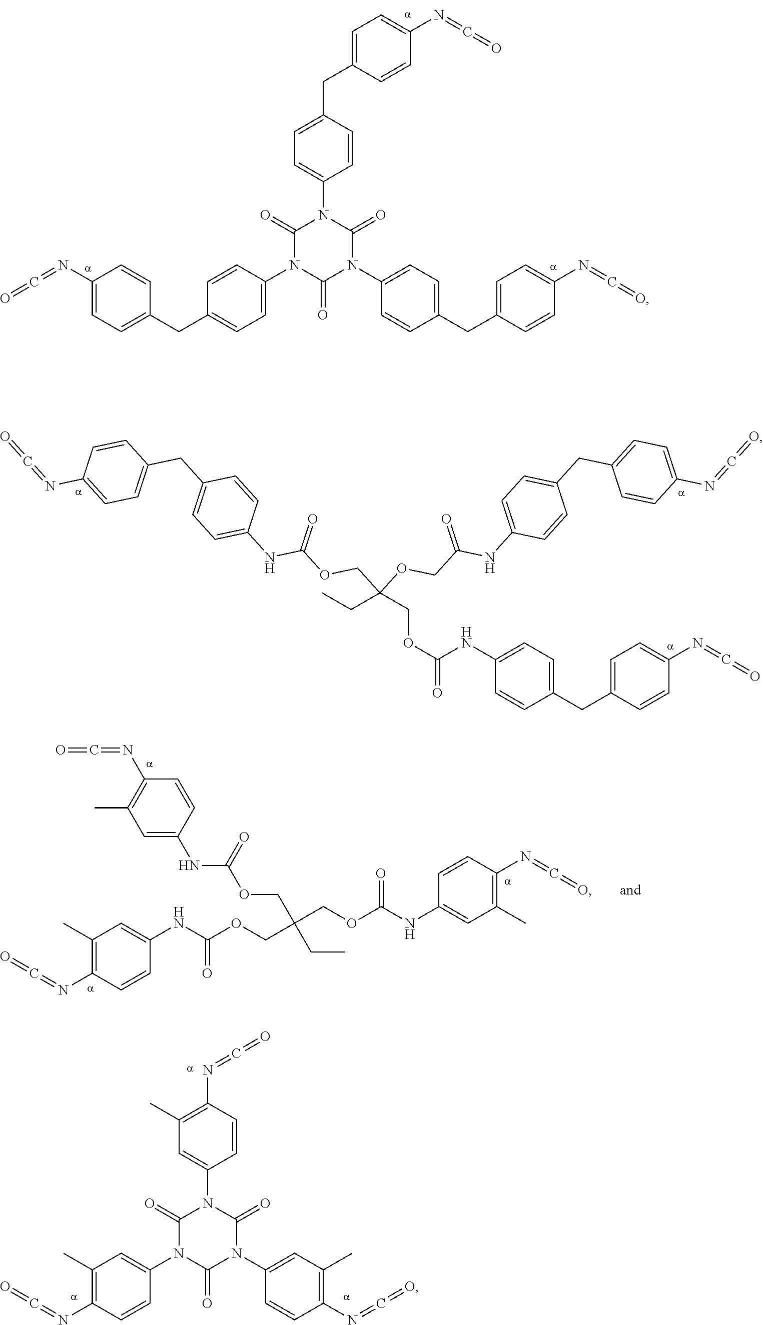 [SMILES: O=C=Nc1ccc(Cc2ccc(-n3c(=O)n(-c4ccc(Cc5ccc(N=C=O)cc5)cc4)c(=O)n(-c4ccc(Cc5ccc(N=C=O)cc5)cc4)c3=O)cc2)cc1 ; CCC(COC(=O)Nc1ccc(Cc2ccc(N=C=O)cc2)cc1)(COC(=O)Nc1ccc(Cc2ccc(N=C=O)cc2)cc1)OCC(=O)Nc1ccc(Cc2ccc(N=C=O)cc2)cc1 ; CCC(COC(=O)Nc1ccc(N=C=O)c(C)c1)(COC(=O)Nc1ccc(N=C=O)c(C)c1)COC(=O)Nc1ccc(N=C=O)c(C)c1 ; Cc1cc(-n2c(=O)n(-c3ccc(N=C=O)c(C)c3)c(=O)n(-c3ccc(N=C=O)c(C)c3)c2=O)ccc1N=C=O]

optionally wherein the alpha-aromatic isocyanate is selected from the group of toluene diisocyanate, methylene diphenyl diisocyanate, polymeric methylene diphenyl diisocyanate, naphthalene diisocyanate, phenylene diisocyanate, isomers thereof, adducts thereof, and combinations thereof.
F. The composition according to any of Paragraphs A to E, wherein the beta-aromatic isocyanate is selected from the group of:

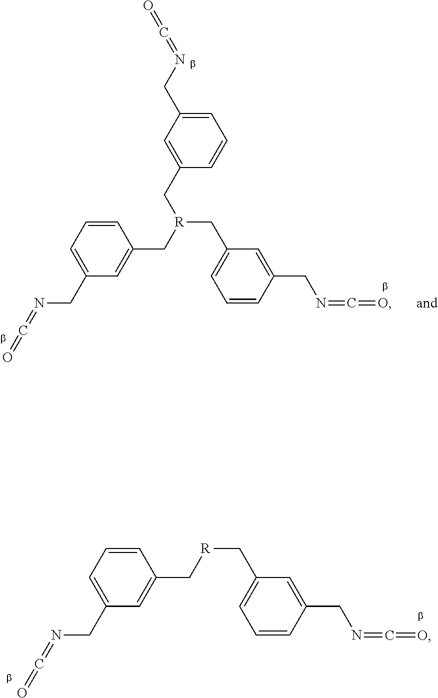

wherein R is a biuret, a uretdione, an isocyanurate, a polyol, a polyol having a urethane group, a urea, a polyamine, a polyamine having a urea group, a polyacid with an anhydride group, a poly-isocyanate comprising a biuret, a poly-isocyanate comprising a uretdione, or a polyisocyanate comprising an isocyanurate,
   optionally,
   wherein the beta-aromatic isocyanate selected from the group of:

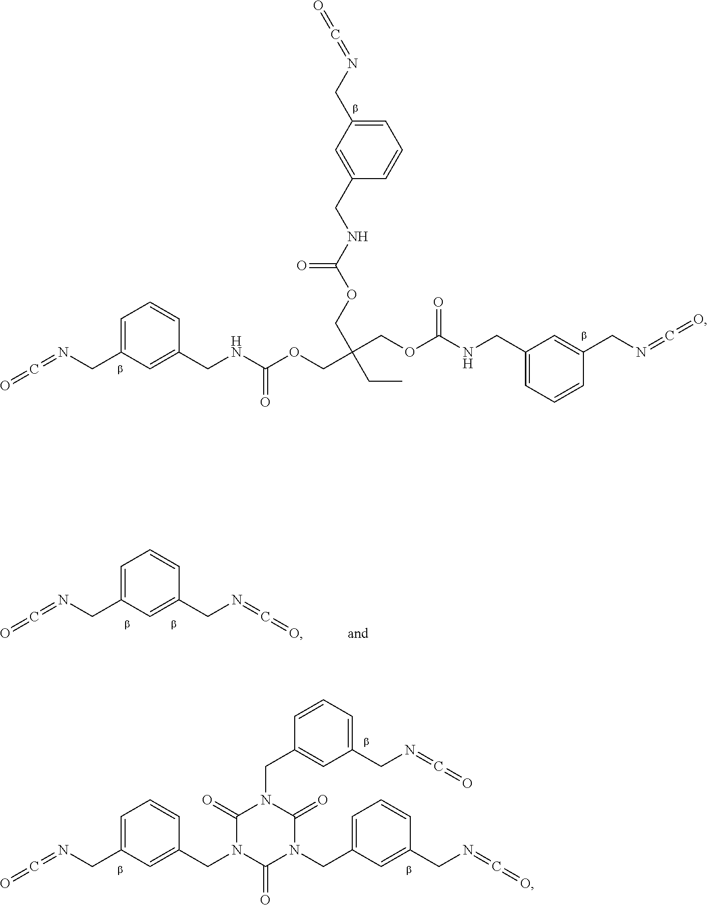 [SMILES: CCC(COC(=O)NCc1cccc(CN=C=O)c1)(COC(=O)NCc1cccc(CN=C=O)c1)COC(=O)NCc1cccc(CN=C=O)c1 ; O=C=NCc1cccc(CN=C=O)c1 ; O=C=NCc1cccc(Cn2c(=O)n(Cc3cccc(CN=C=O)c3)c(=O)n(Cc3cccc(CN=C=O)c3)c2=O)c1]

optionally, wherein the beta-aromatic isocyanate is selected from the group of xylylene diisocyanate, trimethylolpropane adducts of xylylene diisocyanate, tetramethylxylidene diisocyanate, isomers thereof, adducts thereof, and combinations thereof.
G. The composition according to any of Paragraphs A to F, wherein the isocyanate component comprises at least two di- and/or poly-isocyanates selected from methylenediphenyl diisocyanate, polymeric methylenediphenyl isocyanate, and a trimethylol propane-adduct of xylylene diisocyanate, optionally, wherein the isocyanate component comprises methylenediphenyl isocyanate, polymeric methylenediphenyl isocyanate, and a trimethylol propane-adduct of xylylene diisocyanate in a weight ratio of from 1:2 to 1:1.75, optionally, wherein the isocyanate component comprises by weight 30 to 40%, optionally 34% a combination of methylenediphenyl isocyanate and polymeric methylenediphenyl isocyanate and from 60 to 70%, optionally 66% a trimethylol propane-adduct of xylylene diisocyanate.
H. The composition according to any of Paragraphs A to G, wherein the chitosan is characterized by a weight average molecular weight of from about 100 kDa to about 80,000 kDa, or even from 100 kDa to about 600 kDa, optionally from about 100 kDa to about 500 kDa, optionally from about 100 kDa to about 400 kDa, optionally from about 100 kDa to about 300 kDa, optionally from about 100 kDa to about 200 kDa.
I. The composition according to any of Paragraphs A to H, wherein the ratio of the cross-linking agent to chitosan, based on weight, is 79:21 to 10:90, or even 2:1 to 1:8, or even 1:1 to 1:7.
J. The composition according to any of Paragraphs A to I, wherein the core-shell encapsulate has a ratio of core to shell of at least 75:25, or at least 99:1, or even at least 99.5:0. 5, on the basis of weight.
K. The composition according to any of Paragraphs A to J, wherein the perfume comprises perfume raw materials characterized by a log P of from about 2.5 to about 4.5.
L. The composition according to any of Paragraphs A to K, wherein the capsules have a median particle size of from 1 to 200 microns.
M. The composition according to any of Paragraphs A to L, wherein said water-soluble carrier is a water-soluble polymer.
N. The composition according to any of Paragraphs A to M, wherein said water-soluble carrier is selected from the group of:
   a polyalkylene polymer of formula H—(C₂H₄O)ₓ—(CH(CH₃)CH₂O)_{y}—(C₂H₄O)_{z}—OH wherein x is from 50 to 300, y is from 20 to 100, and z is from 10 to 200;
   a polyethylene glycol fatty acid ester of formula (C₂H₄O)_{q}—C(O)O—(CH₂)ᵣ—CH₃ wherein q is from 20 to 200 and r is from 10 to 30;
   a polyethylene glycol fatty alcohol ether of formula HO—(C₂H₄O)ₛ—(CH₂)ₜ)—CH₃ wherein s is from 30 to 250 and t is from 10 to 30; C8-C22 alkyl polyalkoxylate comprising more than 40 alkoxylate units;
   polyethylene glycol having a weight average molecular weight from 2000 to 15000; EO/PO/EO block copolymer;
   PO/EO/PO block copolymer;
   EO/PO block copolymer;
   PO/EO block copolymer;
   polypropylene glycol;
   ethoxylated nonionic surfactant having a degree of ethoxylation greater than 30; polyvinyl alcohol;
   polyalkylene glycol having a weight average molecular weight from 2000 to 15000; and mixtures thereof.
Q. The composition according to any of Paragraphs A to M wherein said water-soluble carrier is polyethylene glycol having a weight average molecular weight from about 2000 to about 15000.
P. The composition according to any of Paragraphs A to L, wherein said water-soluble carrier is selected from the group of polyalkylene oxide, polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and mixtures thereof.
Q. The composition according to any of Paragraphs A to P, wherein said plurality of capsules is present at a level of about 0.1% to about 20%, by weight of the composition.
R. The composition according to any of Paragraphs A to Q, wherein said particles have at least one flat surface.
S. The composition according to any of Paragraphs A to R, wherein said plurality of particles comprise individual particles, wherein said individual particles have a density less than about 1 g/cm³, optionally less than about 0.98 g/cm³.
T. The composition according to any of Paragraphs A to S, wherein said perfume is a fragrance of plant origin.
U. The composition according to any of Paragraphs A to L, wherein said carrier comprises:
   from 0% to 3% by weight plasticizer polyol, wherein said plasticizer polyol is optionally a liquid at 20 C and 1 atmosphere of pressure;
   from 1% to 20%, optionally 1% to 12%, optionally 6% to 8%, by weight water;
   from 45% to 80%, optionally 50% to 70%, optionally 50% to 60%, by weight sugar alcohol polyol selected from the group of erythritol, xylitol, mannitol, isomalt, maltitol, lactitol, trehalose, lactose, tagatose, sucralose, and mixtures thereof;
   wherein said particles further comprise:
      (a) modified starch having a dextrose equivalent from 15 to 20 and said sugar alcohol polyol and said modified starch are present at a weight ratio of said sugar alcohol polyol to said modified starch from 2:1 to 16:1, optionally from 2:1 to 10:1, optionally from 2:1 to 3:1; or
      (b) modified starch having a dextrose equivalent from 4 to less than 15 and said sugar alcohol polyol and said modified starch are present at a weight ratio of said sugar alcohol polyol to said modified starch from 1.5:1 to 16:1, optionally from 1.5:1 to 10:1, optionally from 1.5:1 to 4:1;
      wherein said capsules, said water, and said sugar alcohol polyol are dispersed in said modified starch.
V. The composition according to Paragraph U, wherein said modified starch has a dextrose equivalent from 15 to 20 and said sugar alcohol polyol and said modified starch are present at a ratio from 2:1 to 16:1, optionally from 2:1 to 10:1, optionally from 2:1 to 3:1.
W. The composition according to Paragraph U, wherein said modified starch has a dextrose equivalent from 4 to less than 15 and said sugar alcohol polyol and said modified starch are present at a weight ratio of said sugar alcohol polyol to said modified starch from 1.5:1 to 16:1, optionally from 1.5:1 to 10:1, optionally from 1.5:1 to 4:1.
X. The composition according to Paragraph W, wherein said modified starch has a dextrose equivalent from 4 to 12.
Y. The composition according to any of Paragraphs U to X, wherein said modified starch is maltodextrin.
Z. The composition according to any of Paragraphs U to Y, wherein said sugar alcohol polyol is mannitol.
AA. The composition according to any of Paragraphs A to L, wherein said carrier comprises:
   from 0% to 3% by weight plasticizer polyol that is liquid at 20 C and 1 atmosphere of pressure;
   from 1% to 20%, optionally from 1% to 12%, optionally from 6% to 8%, by weight water;
   from 15% to 40%, optionally from 20% to 30%, by weight sugar alcohol polyol selected from the group of erythritol, xylitol, mannitol, isomalt, maltitol, lactitol, trehalose, lactose, tagatose, sucralose, and mixtures thereof; and
   modified starch having a dextrose equivalent from 4 to less than 15 and said sugar alcohol polyol and said modified starch are present at a weight ratio of said sugar alcohol polyol to said modified starch from 1:5 to 1:1;
   wherein said capsules, said water, and said sugar alcohol polyol are dispersed in said modified starch; and
   wherein said particles each have an exterior surface and an anti-caking agent is on said exterior surface.
AA1. The composition according to any of Paragraphs A to L, wherein said carrier comprises: from 0% to 3% by weight plasticizer polyol, wherein said plasticizer polyol is optionally a liquid at 20 C and 1 atmosphere of pressure;
   from 1% to 20%, optionally 1% to 12%, optionally 6% to 8%, by weight water;
   from 45% to 80%, optionally 50% to 70%, optionally 50% to 60%, by weight sugar alcohol polyol selected from the group of erythritol, xylitol, mannitol, isomalt, maltitol, lactitol, trehalose, lactose, tagatose, sucralose, and mixtures thereof;
   wherein said particles further comprise:
      (a) modified starch having a dextrose equivalent from 15 to 20 and said sugar alcohol polyol and said modified starch are present at a weight ratio of said sugar alcohol polyol to said modified starch from 2:1 to 16:1, optionally from 2:1 to 10:1, optionally from 2:1 to 3:1; or
      (b) modified starch having a dextrose equivalent from 4 to less than 15 and said sugar alcohol polyol and said modified starch are present at a weight ratio of said sugar alcohol polyol to said modified starch from 1.5:1 to 16:1, optionally from 1.5:1 to 10:1, optionally from 1.5:1 to 4:1;
      wherein said capsules, said water, and said sugar alcohol polyol are dispersed in said modified starch.
AA2. The composition according to Paragraph AA1, wherein said modified starch has a dextrose equivalent from 15 to 20 and said sugar alcohol polyol and said modified starch are present at a ratio from 2:1 to 16:1, optionally from 2:1 to 10:1, optionally from 2:1 to 3:1.
AA3. The composition according to Paragraph AA1, wherein said modified starch has a dextrose equivalent from 4 to less than 15 and said sugar alcohol polyol and said modified starch are present at a weight ratio of said sugar alcohol polyol to said modified starch from 1.5:1 to 16:1, optionally from 1.5:1 to 10:1, optionally from 1.5:1 to 4:1.
AA4. The composition according to Paragraph AA3, wherein said modified starch has a dextrose equivalent from 4 to 12.
AA5. The composition according to any of Paragraphs AA1 to AA4, wherein said modified starch is maltodextrin.
AA6. The composition according to any of Paragraphs AA1 to AA5, wherein said sugar alcohol polyol is mannitol.
AA7. The composition according to any of Paragraphs A to L, wherein said carrier comprises:
   from 0% to 3% by weight plasticizer polyol that is liquid at 20 C and 1 atmosphere of pressure;
   from 1% to 10%, optionally from 3% to 8%, by weight water;
   from 15% to 40%, optionally from 20% to 30%, by weight sugar alcohol polyol selected from the group of erythritol, xylitol, mannitol, isomalt, maltitol, lactitol, trehalose, lactose, tagatose, sucralose, and mixtures thereof; and
   modified starch having a dextrose equivalent from 4 to less than 15 and said sugar alcohol polyol and said modified starch are present at a weight ratio of said sugar alcohol polyol to said modified starch from 1:5 to 1:1;
   wherein said capsules, said water, and said sugar alcohol polyol are dispersed in said modified starch; and
   wherein said particles each have an exterior surface and an anti-caking agent is on said exterior surface.
BB. A process for treating laundry comprising the steps of:
   providing an article of laundry in a washing machine;
   dispensing said plurality of particles according to any of Paragraphs A to AA7 into said washing machine; and
   contacting said article of laundry during a wash sub-cycle of said washing machine with said plurality of particles.
CC. The process according to Paragraph BB further comprising a step of dispensing into said washing machine a laundry detergent comprising from about 3% to about 60% by weight anionic or nonionic surfactant.
DD. The process according to Paragraph BB or CC, wherein about 5 g to about 50 g of said plurality of particles is dispensed into said washing machine.
EE. A process for forming the plurality of particles according to any of Paragraphs A to AA comprising the steps of:
   providing a melt composition comprising said water-soluble carrier and said capsules;
   passing said melt composition through one or more apertures of a distributor; and
   depositing said melt composition on a moving conveyor beneath said one or more apertures.

### Test Methods

It is understood that the test methods that are disclosed in the Test Methods section of the present application should be used to determine the respective values of the parameters of Applicant's claimed subject matter as claimed and described herein.

### Volume-Weighted Particle Size and Size Distribution

The volume-weighted particle size distribution is determined via single-particle optical sensing (SPOS), also called optical particle counting (OPC), using the AccuSizer 780 AD instrument and the accompanying software CW788 version 1.82 (Particle Sizing Systems, Santa Barbara, California, U.S.A.), or equivalent. The instrument is configured with the following conditions and selections: Flow Rate=1 ml/sec; Lower Size Threshold=0.50 μm; Sensor Model Number=Sensor Model Number=LE400-05 or equivalent; Autodilution=On; Collection time=60 sec; Number channels=512; Vessel fluid volume=50 ml; Max coincidence=9200. The measurement is initiated by putting the sensor into a cold state by flushing with water until background counts are less than 100. A sample of delivery capsules in suspension is introduced, and its density of capsules adjusted with DI water as necessary via autodilution to result in capsule counts of at least 9200 per ml. During a time period of 60 seconds the suspension is analyzed. The resulting volume-weighted PSD data are plotted and recorded, and the values of the desired volume-weighted particle size (e.g., the median/50^{th} percentile, 5^{th} percentile, and/or 90^{th} percentile) are determined.

### Procedure for Determination of % Degradation

% degradation is determined by the “OECD Guideline for Testing of Chemicals” 301B CO₂ Evolution (Modified Sturm Test), adopted 17 Jul. 1992. For ease of reference, this test method is referred to herein as test method OECD 301B.

### Spray-Drying Procedure

This method transforms the microcapsule slurry into a powder by removing the water in the slurry via spray drying. The slurry is diluted to 19-21% solids via RO water. The slurry is then spraydried on a Buchi Mini Spray Dryer B-290 with an inlet temperature of 180 C, aspirator of 90%, and pump of 20-65% to target an outlet temperature of 90 C. The resulting spray-dried microcapsule powder is collected from the collection vessel.

### Laundry Care Particles Making Procedure

PEG 8000 is melted in the oven at 80 C. After the PEG 8000 becomes entirely molten, it is removed from the oven and allowed to cool to 60 C. The delivery particle slurry is added to the molten PEG 8000 blended with a spatula. The blend is put back into the oven for 3 hours to simulate the production process. Afterwards, it is removed from the oven and poured onto a mold to form the Laundry care particles. The blend is left to cool and is demolded to obtain the final laundry care particles product containing the delivery particles.

Determining Amount of Perfume Loss after Making of Laundry Care Particles

1.25 g of the laundry care particles containing (encapsulated) perfume is dissolved in 100 g water. From this solution a 1.00 g sample is taken and pipetted into a 20 ml headspace vial. The headspace above the solution is analyzed using SPME headspace GC/MS (gas chromatography mass spectrometry) approach. The sample is incubated at 30 C for 10 min. The headspace above the solution is sampled via SPME (50/30 μm DVB/Carboxen/PDMS) for 1 min. The SPME fiber is subsequently on-line thermally desorbed into the GC for 5 min. The analytes are analyzed by GC/MS in full scan mode with a Split ratio of 1:10. The total perfume HS response and perfume headspace composition above the tested legs can be determined.

The total perfume HS response obtained via the method described above is measured for a Bead sample containing a certain type and amount of non-encapsulated fragrance material. This is considered the reference value which represents 100% of perfume leaked from the delivery particle.

This total perfume HS response is compared to the total HS response obtained for a Bead sample containing the same type and amount of encapsulated fragrance material. When these two values are compared to each other the amount of perfume leaked from the delivery particle can be determined through the following equation:

$$\% Perfume Loss after making of Laundry care particles ( \% ) = \frac{Total perfume {HS}_{Encapsulated perfume}}{Total perfume {HS}_{Non - encapsulated perfume}}$$

### Procedure for Determination of Free Oil of Spray-Drying

This method determines the “Free Oil of Spraydried Powder” of the microcapsule powder. 200-250 mg of powder is placed and measured into a 20 mL scintillation vial. 10 mL hexane is added. The vial is capped and vortexed at 3000 RPM for 5 seconds, and then sit at 2 minutes to settle solids. At least 2 mL of the solvent solution is extracted via a syringe, and then filtered through a 0.45 um syringe filter into a Gas Chromatography (GC) injection vial. The solution is injected into the GC instrument and the concentration of perfume in the solvent is determined, via reference to a calibration curve created by serial dilutions of perfume dissolved in hexane. The “Free Oil of Spraydried Powder” is then calculated as the mass fraction of perfume in the 10 mL of hexane relative to the mass of the powder. For a sample of powder, two duplicates of this procedure are done, and the results are averaged. The standard deviation is calculated from the two points and provided with the average value.

### Sample Preparation for Biodegradability Measurements

The water-soluble or water dispersible material is purified via crystallization till a purity of above 95% is achieved and dried before biodegradability measurement.

The oily medium comprising the benefit agent needs to be extracted from the capsules slurry in order to only analyze the polymer wall. Therefore, the capsules slurry is freeze dried to obtain a powder. Then, it is further washed with organic solvents via Soxhlet extraction method to extract the oily medium comprising the benefit agent till weight percentage of oily medium is below 5% based on total capsule polymer wall. Finally, the polymer wall is dried and analyzed.

Weight ratio of capsule to solvent is 1:3. Residual oily medium is determined by thermogravimetric analysis (60 minutes isotherm at 100° C. and another 60 minutes isotherm at 250° C.). The weight loss determined needs to be below 5%.

### Leakage Procedure

The amount of benefit agent leakage from the benefit agent containing capsules is determined according to the following method:
i) Obtain two 1 g samples of benefit agent containing capsules.
ii) Add 1 g of benefit agent containing capsules to 99 g of the consumer product matrix in which the particles will be employed and label the mixture as Sample 1. Immediately use the second 1 g sample of benefit agent containing capsules in Step d below, in its neat form without contacting consumer product matrix, and label it as Sample 2.
iii) Age the capsules-containing product matrix (Sample 1) for 1 week at 35° C. in a sealed glass jar.
iv) Using filtration, recover the capsules from both samples. The particles in Sample 1 (in consumer product matrix) are recovered after the aging step. The particles in Sample 2 (neat raw material slurry) are recovered at the same time that the aging step began for sample 1.
v) Treat the recovered particles with a solvent to extract the benefit agent materials from the particles.
vi) Analyze the solvent containing the extracted benefit agent from each sample, via chromatography.
vii) Integrate the resultant benefit agent peak areas under the curve and sum these areas to determine the total quantity of benefit agent extracted from each sample.
viii) Determine the percentage of benefit agent leakage by calculating the difference in the values obtained for the total quantity of benefit agent extracted from Sample 2 (S2) minus Sample 1 (S1), expressed as a percentage of the total quantity of benefit agent extracted from Sample 2 (S2), as represented in the equation below:

$$\% Leakage = ( \frac{S 2 - S 1}{S 2} ) \times 100$$

Two duplicates of this procedure are done, and the results are averaged. The standard deviation is calculated from the two points and provided with the average value. Method of olfactive evaluation

### Method to Determine Headspace Concentration Above Treated Dry Fabrics.

The cotton tracers are analyzed by a fast headspace GC/MS (gas chromatography mass spectrometry) approach. 4×4 cm aliquots of the terry towel cotton tracers were transferred to 25 ml headspace vials. The fabric samples were equilibrated for 10 minutes@65° C. The headspace above the fabrics was sampled via SPME (50/30 μm DVB/Carboxen/PDMS) approach for 5 minutes. The SPME fiber was subsequently on-line thermally desorbed into the GC. The analytes were analyzed by fast GC/MS in full scan mode. Ion extraction of the specific masses of the PRMs was used to calculate the total HS response and perfume headspace composition above the tested legs.

### % NCO

The % NCO of Isocyanate compounds is calculated as below Equation:

$$\% NCO = \frac{Number of NCO groups \cdot M W NCO group}{M W Isocyanate compound}$$

Where Number of NCO groups is the count of isocyanate groups present in the compound, MW NCO group is the molecular weight of a single NCO group, MW Isocyanate compound is the molecular weight of the entire isocyanate compound, excluding any solvent or other substances that may be mixed with the isocyanate.
When isocyanate is used as a mixture of multiple isocyanates, the % NCO is reported as the weighted sum of mass percentages for each individual isocyanate within the mixture.

All temperatures herein are in degrees Celsius (° C.) unless otherwise indicated. Unless otherwise specified, all measurements herein are conducted at 20° C. and under the atmospheric pressure.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

In the following examples, the abbreviations, materials or tradenames correspond to the materials listed in Table 3. The examples are intended to be illustrative in nature and are not intended to be limiting.

TABLE 3
Materials - chitosan

| Trade Name | Company/City | Material |
|---|---|---|
| CHITOCLEAR | Primex EHF, Siglufjordur, Iceland | chitosan |

The di- and/or poly-isocyanates comprise an aromatic moiety. The isocyanates employed have two functional groups: an isocyanate group and an aromatic moiety. For ease of reference, the isocyanate molecules can be subdivided into several classifications.
A first grouping can be on the basis of the presence or absence of an aromatic moiety within the whole molecule; hence the following two classification are defined:
1—isocyanate comprising at least one aromatic moiety.
2—isocyanate not comprising any aromatic moiety.
   For convenience, the presence of the aromatic moiety can be further classified as either alpha or beta based on carbon-atom naming. Hence the isocyanate comprising an aromatic moiety can be subdivided.
1. i) isocyanate comprising an alpha-aromatic moiety; and,
1. ii) isocyanate comprising a beta-aromatic moiety.
   For ease of reference, Group 1, i) and ii) classifications are then referred to as:
1. i) alpha-aromatic
1. ii) beta-aromatic
   and Group 2 as
2. “non-aromatic”
   This naming convention is reflected in Table 4 below:

TABLE 4
Materials-isocyanate

| Trade | | | | | |
|---|---|---|---|---|---|
| Name | Company/City | Material | Chemical structure | Classification | NCO |
| TAKENATE D- 110N | Mitsui Chemicals America, Inc., Rye Brook, NY | polyisocyanate prepolymer; adduct of xylylene diisocyanate | 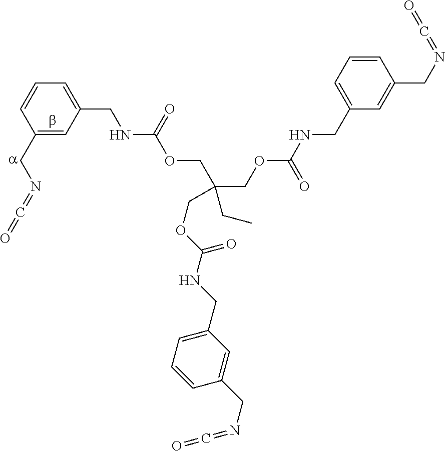 | Beta- Aromatic | 15.3% |
| MMRL MONDUR MR- LIGHT | Covestro LLC Pittsburgh, PA | polymeric diphenyl- methane diisocyanate | 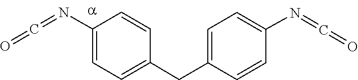 [SMILES: O=C=Nc1ccc(Cc2ccc(N=C=O)cc2)cc1] | Alpha- Aromatic | 31.3% |
| LUPRANATE M20 ISOCYANATE | BASF, Florham Park, NJ | polymethylene polyphenyl- polyisocyanate | 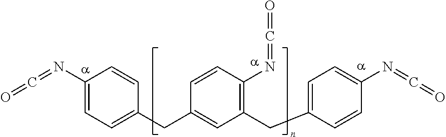 | Alpha- Aromatic | 31.5% |

It is theorized that the aromatic ring can affect reactivity. Surprisingly it was found that isocyanate comprising alpha-aromatic moieties are more reactive than isocyanate comprising beta-aromatic moieties. This is believed due to the nature of the electron-withdrawing aromatic ring, enhancing the electrophilic character of the isocyanate group (NCO). Isocyanate comprising alpha-aromatic moiety or moieties have a phenyl ring attached to the NCO group, which is theorized to enhance reactivity. The delocalization of electrons in the aromatic ring is believed to make the alpha carbon even more electron-deficient, making it a stronger electrophile, hence more prone to nucleophilic interaction with amines such with the chitosan amine group. Isocyanate comprising a beta-aromatic moiety or moieties, on the other hand, have less of the influence of an electron-withdrawing aromatic ring and are attached to the beta carbon. While they are still reactive, they are generally less reactive than their alpha-aromatic isocyanate counterparts. This can lead to faster reaction rates, making the alpha-aromatic isocyanates, such as of Group 1 i), more efficient in certain applications. However, their high reactivity can also make them more challenging to handle and may require additional precautions such as the potential unwanted reactivity with PRMs. Surprising, unexpected improvements were found when the isocyanate component is selected to comprises a mixture of two or more isocyanates each comprising an aromatic moiety; and each isocyanate is independently selected from the group of an alpha-aromatic isocyanate and a beta-aromatic isocyanate. It is to be understood that the isocyanate can be di- or polyisocyanate.

### EXAMPLES

The examples provided below are intended to be illustrative in nature and are not intended to be limiting.

### Example 1

Determining the Amount of Perfume Loss after Making of Laundry Care Particles

Laundry care particles were made according to making method described above (laundry care particles making procedure). Below Table 5 represents Laundry care particles comprising perfume capsules as described herein.

TABLE 5
Laundry care particles composition

| Ingredients | % Active (wt %) |
|---|---|
| Polyethylene glycol (PLURIOL E8000 from BASF) | 87.26 |
| Cyan 15 dye solution | 0.012 |
| Perfume microcapsules as described herein | 2.7 |
| Water | To 100 |

The perfume Loss after making of Laundry care particles was assessed according to the method “Determining the Amount of Perfume Loss after making of laundry care particles” provided in the Test Methods section above.

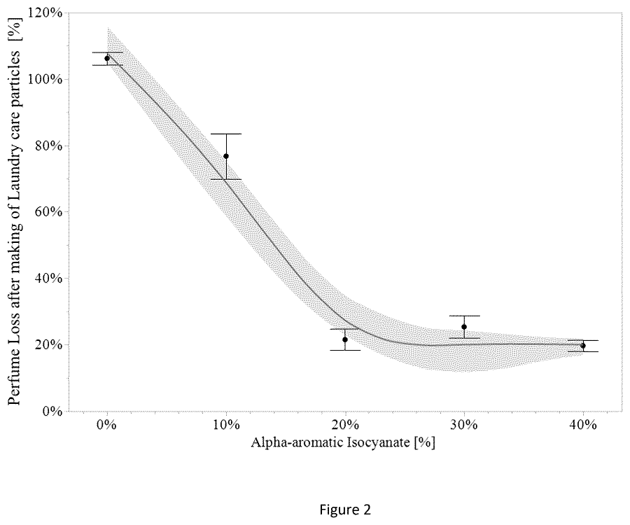

Table 6 highlights that Comparative Example 1, which is characterized by a single Beta-aromatic Isocyanate, exhibits the highest amount of Perfume Loss after making of laundry care particles. Moreover, Table 6 and FIG. 2 highlight that by increasing the amount of Alpha-aromatic Isocyanate the perfume loss diminishes till to reach the lowest values around 20% and 40% in Alpha-aromatic Isocyanate weighted concentration.

TABLE 6
Perfume Loss after making of Laundry care particles comprising capsules made with
different ratios of Alpha-aromatic isocyanates and Beta-aromatic isocyanates.

| | | | | | | | | Perfume Loss |
|---|---|---|---|---|---|---|---|---|
| | | | | | | | | after making |
| | Beta-aromatic Isocyanate | | | Alpha-aromatic Isocyanate | | | | of Laundry |
| | | Amount | | | Amount | | Weighted | care particles |
| Example | Name | (g) | % | Name | (g) | % | NCO % | [%] |
| Comparative | Takenate D- | 4.81 | 100% | Mondur MR- | 0 | 0% | 15.30% | 106.1 + 1.9 |
| Example 1 | 110N | | | Light | | | | |
| Example 1A | Takenate D- | 4.33 | 90% | Mondur MR- | 0.36 | 10% | 16.90% | 76.7 + 6.9 |
| | 110N | | | Light | | | | |
| Example 1B | Takenate D- | 3.85 | 80% | Mondur MR- | 0.72 | 20% | 18.50% | 23.9 + 2.5 |
| | 110N | | | Light | | | | |
| Example 1D | Takenate D- | 3.37 | 70% | Mondur MR- | 1.08 | 30% | 20.10% | 25.3 + 3.4 |
| | 110N | | | Light | | | | |
| Example 1E | Takenate D- | 2.89 | 60% | Mondur MR- | 1.44 | 40% | 21.70% | 19.6 + 1.7 |
| | 110N | | | Light | | | | |

### Example 2

Population of Capsules that have Undergone a Drying Process Involving Heating to Remove the Water Content.”

Perfume capsules as described herein underwent a spray-drying process as described in the method “Spray-drying procedure” provided in the Methods section above.

Free Oil after Spray-drying was assessed according to the method “Procedure for Determination of Free Oil after Spray-drying” provided in the Methods section above.

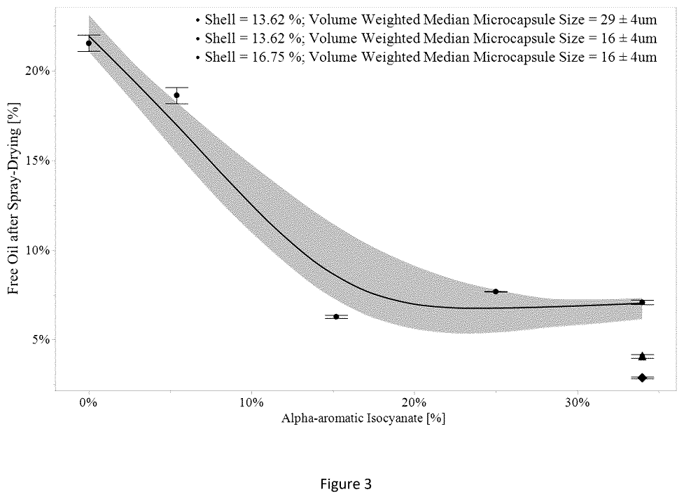

Table 7 highlights that Comparative Example 1, characterized by a single Beta-aromatic Isocyanate, exhibited the highest amount of Free Oil after Spray-drying. Moreover, Table 6 and FIG. 3 highlight that increasing the amount of Alpha-aromatic Isocyanate led to a reduction in Free oil after Spray-drying, reaching the lowest values at approximately 15% and 40% in terms of Alpha-aromatic Isocyanate weighted concentration. Moreover, Table 6 and FIG. 3 underline that reducing the Volume Weighted Median Microcapsule Size from 29±4 μm to 16±4 μm and increasing the Shell (%) further contributed to the reduction of Free Oil after Spray-drying to values of 2.9±0.0%.

TABLE 7
Free Oil after SprayDrying capsules made with different ratios of Alpha-aromatic isocyanates and Beta-
aromatic isocyanates and varying Shell (%) and Volume Weighted Median Microcapsule Size (um).

| | | | | | | | | Volume | | |
|---|---|---|---|---|---|---|---|---|---|---|
| | | | | | | | | Weighted | | |
| | Beta-aromatic Isocyanate | | | Alpha-aromatic Isocyanate | | | | Median | | Free Oil after |
| | | Amount | | | Amount | | Weighted | Microcapsule | | SprayDrying |
| Example | Name | (g) | % | Name | (g) | % | NCO % | Size (um) | Shell (%) | [%] |
| Comparative | Takenate D- | 4.81 | 100 | Mondur MR- | 0 | 0 | 15.3 | 29 ± 4 | 13.6 | 21.5 ± 0.3 |
| Example 1 | 110N | | | Light | | | | | | |
| Example 1A | Takenate D- | 4.55 | 94.6 | Mondur MR- | 0.2 | 5.4 | 16.2 | 29 ± 4 | 13.6 | 18.6 ± 0.3 |
| | 110N | | | Light | | | | | | |
| Example 1B | Takenate D- | 4.08 | 84.8 | Mondur MR- | 0.55 | 15.2 | 17.7 | 29 ± 4 | 13.6 | 6.3 ± 0.1 |
| | 110N | | | Light | | | | | | |
| Example 1C | Takenate D- | 3.61 | 75 | Mondur MR- | 0.9 | 25 | 19.3 | 29 ± 4 | 13.6 | 7.7 ± 0.0 |
| | 110N | | | Light | | | | | | |
| Example 1D | Takenate D- | 3.22 | 66 | Mondur MR- | 1.24 | 34 | 20.7 | 29 ± 4 | 13.6 | 7.1 ± 0.1 |
| | 110N | | | Light | | | | | | |
| Example 1G | Takenate D- | 3.22 | 66 | Mondur MR- | 1.24 | 34 | 20.7 | 16 ± 4 | 13.6 | 4.1 ± 0.1 |
| | 110N | | | Light | | | | | | |
| Example 1H | Takenate D- | 3.22 | 66 | Mondur MR- | 1.24 | 34 | 20.7 | 16 ± 4 | 16.7 | 2.9 ± 0.0 |
| | 110N | | | Light | | | | | | |

### Example 4

### Laundry Care Particles Compositions

In Table 8 examples of Laundry care particles compositions are reported.

TABLE 8

| | Laundry care particles compositions | | | | | | | | |
|---|---|---|---|---|---|---|---|---|---|
| | % Active (wt %) | | | | | | | | |
| | Example | Example | Example | Example | Example | Example | Example | Example | Example |
| Ingredients | 4A | 4B | 4C | 4D | 4E | 4F | 4G | 4H | 4I |
| Polyethylene glycol | 60 | 80 | — | 55 | 75 | — | 89.2 | 87.2 | 82.2 |
| Cyan 15 dye solution | — | — | — | — | — | — | 0 | 0 | 0.01 |
| Unencapsulated | — | — | — | 7.5 | 5 | 6 | 7.5 | 7.5 | 8 |
| perfume oil | | | | | | | | | |
| Modified starch, | — | — | 17 | — | — | 15.7 | — | — | — |
| maltodextrin M100 | | | | | | | | | |
| Sugar alcohol | — | — | 54 | — | — | 50 | — | — | — |
| polyol** | | | | | | | | | |
| Starch and or sodium | 35 | 14 | 9.5 | 35 | 15 | 9.5 | — | — | — |
| sulfate | | | | | | | | | |
| Perfume capsules as | 2 | 3 | 2.5 | 2 | 3 | 2.5 | 0.7 | 2.7 | 2.7 |
| described herein | | | | | | | | | |
| Water | To 100 | To 100 | To 100 | To 100 | To 100 | To 100 | To 100 | To 100 | To 100 |

*Having a weight average molecular weight of 9000
**Selected from the group of mannitol, maltitol, erythritol, isomalt, sorbitol, and mixtures thereof

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising a plurality of particles, wherein said particles comprise:
about 25% to about 99% by weight water-soluble carrier; and
a plurality of capsules dispersed in said water-soluble carrier, wherein said capsules comprise a core and a shell surrounding said core and said core comprises perfume raw materials;
wherein said shell comprises from about 90% to 100%, optionally from about 95% to 100%, optionally from about 99% to 100% by weight of the shell of a polymeric material that is the reaction product of chitosan derived from an aqueous phase and a cross-linking agent, wherein the cross-linking agent comprises an isocyanate component, the isocyanate component comprising a mixture of two or more di- and/or poly-isocyanates, derived from an oil phase, the di- and/or poly-isocyanates each comprising an aromatic moiety; and
wherein the mixture of di- and/or poly-isocyanates comprising an aromatic moiety comprises at least one alpha-aromatic isocyanate and at least one beta-aromatic isocyanate, optionally, wherein the required isocyanates are each present in at least 20 mole percent of the total isocyanate component.

2. The composition according to claim 1, wherein the weighted % NCO of the di- and/or poly-isocyanates comprising an aromatic moiety within the isocyanate component is from 15 to 32% by weight, or even from 21 to 25% by weight, and wherein:
the % NCO of Isocyanate compounds is calculated as below Equation:
$$\% NCO = \frac{Number of NCO groups \cdot M W NCO group}{M W Isocyanate compound}$$
where Number of isocyanate groups (NCO groups) is the count of isocyanate groups present in the compound, MW NCO group is the molecular weight of a single NCO group, MW Isocyanate compound is the molecular weight of the entire isocyanate compound, excluding any solvent or other substances that may be mixed with the isocyanate.

3. The composition according to claim 1, wherein a mass percent of the alpha-aromatic isocyanate in the isocyanate component is from 1 to 99% by weight.

4. The composition according to claim 1, wherein the mass percent of the alpha-aromatic isocyanate in the isocyanate component is from 5 to 90% by weight.

5. The composition according to claim 1, wherein the mass percent of the beta-aromatic isocyanate in the isocyanate component is from 1% to 99% by weight.

6. The composition according to claim 1, wherein the mass percent of the beta-aromatic isocyanate in the isocyanate component is from 5% to 10% by weight.

7. The composition according to claim 1, wherein the alpha-aromatic isocyanate is selected from the group of: 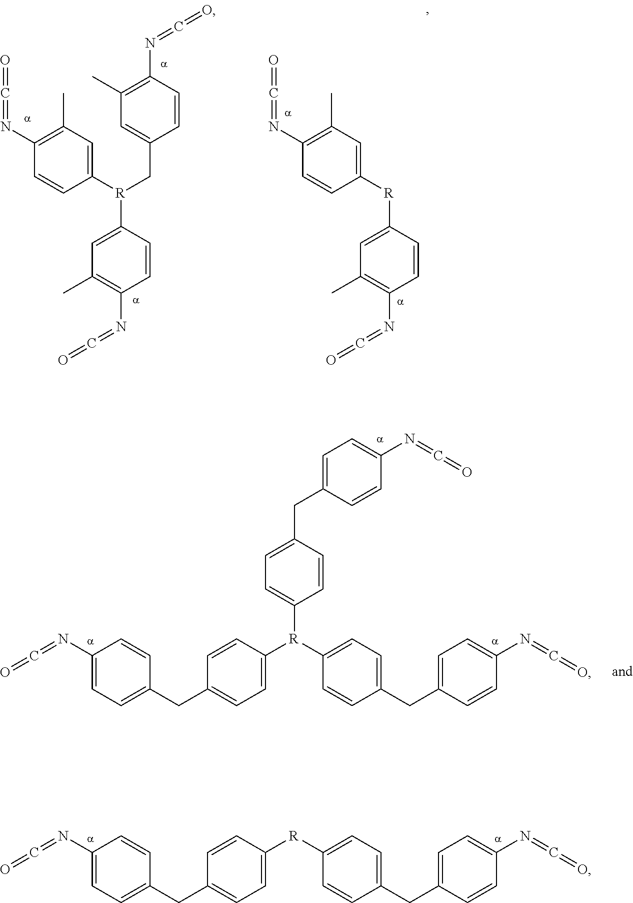
wherein R is a biuret, a uretdione, a isocyanurate, a polyol, a polyol having a urethane group, a urea, a polyamine, a polyamine having a urea group, a polyacid with an anhydride group, a poly-isocyanate comprising a biuret, a poly-isocyanate comprising a uretdione, or a polyisocyanate comprising an isocyanurate,
optionally, wherein the alpha-aromatic isocyanate is selected from the group of: 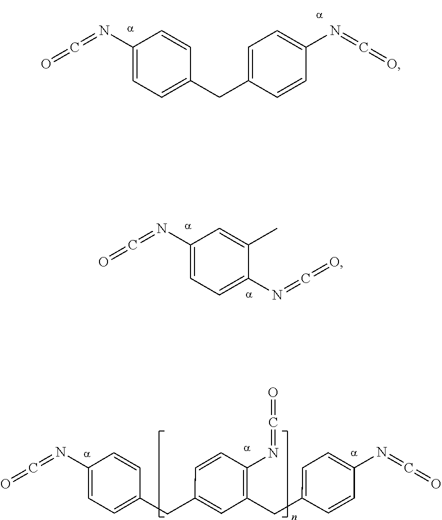
wherein n is an integer from 1 to 24, 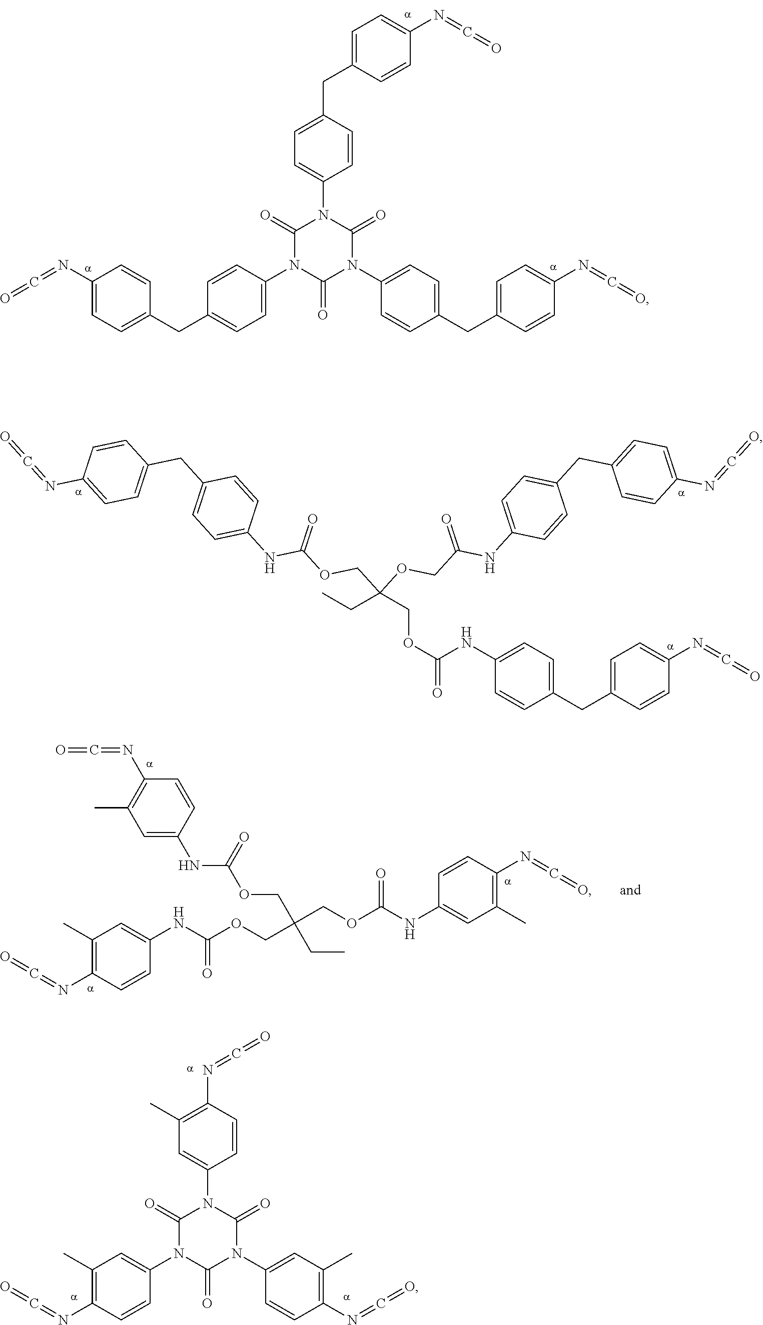 [SMILES: O=C=Nc1ccc(Cc2ccc(-n3c(=O)n(-c4ccc(Cc5ccc(N=C=O)cc5)cc4)c(=O)n(-c4ccc(Cc5ccc(N=C=O)cc5)cc4)c3=O)cc2)cc1 ; CCC(COC(=O)Nc1ccc(Cc2ccc(N=C=O)cc2)cc1)(COC(=O)Nc1ccc(Cc2ccc(N=C=O)cc2)cc1)OCC(=O)Nc1ccc(Cc2ccc(N=C=O)cc2)cc1 ; CCC(COC(=O)Nc1ccc(N=C=O)c(C)c1)(COC(=O)Nc1ccc(N=C=O)c(C)c1)COC(=O)Nc1ccc(N=C=O)c(C)c1 ; Cc1cc(-n2c(=O)n(-c3ccc(N=C=O)c(C)c3)c(=O)n(-c3ccc(N=C=O)c(C)c3)c2=O)ccc1N=C=O]
optionally, wherein the alpha-aromatic isocyanate is selected from the group of toluene diisocyanate, methylene diphenyl diisocyanate, polymeric methylene diphenyl diisocyanate, naphthalene diisocyanate, phenylene diisocyanate, isomers thereof, adducts thereof, and combinations thereof.

8. The composition according to claim 1, wherein the beta-aromatic isocyanate is selected from the group of: 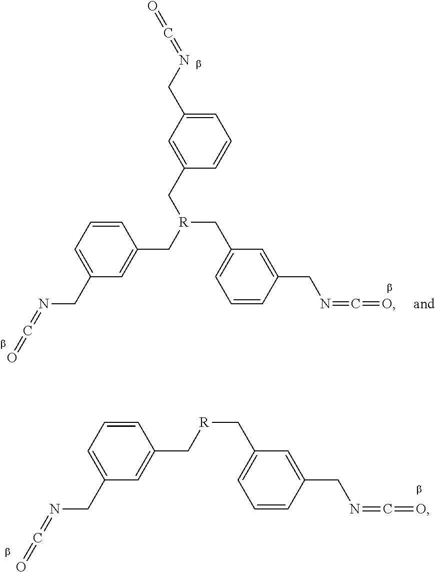
wherein R is a biuret, a uretdione, a isocyanurate, a polyol, a polyol having a urethane group, a urea, a polyamine, a polyamine having a urea group, a polyacid with an anhydride group, a poly-isocyanate comprising a biuret, a poly-isocyanate comprising a uretdione, or a polyisocyanate comprising an isocyanurate,
optionally,
wherein the beta-aromatic isocyanate selected from the group of: 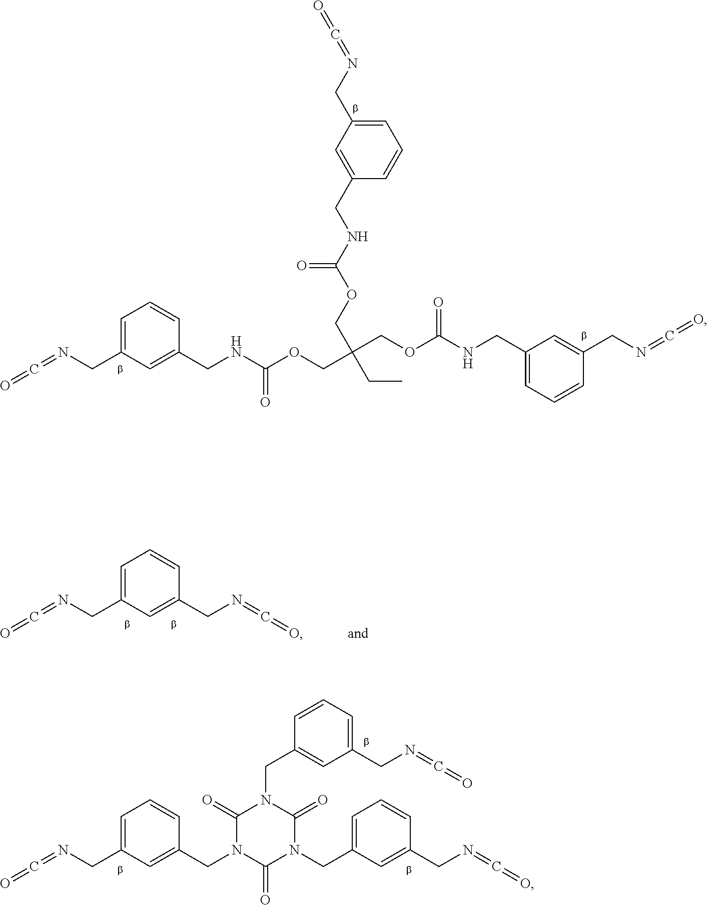 [SMILES: CCC(COC(=O)NCc1cccc(CN=C=O)c1)(COC(=O)NCc1cccc(CN=C=O)c1)COC(=O)NCc1cccc(CN=C=O)c1 ; O=C=NCc1cccc(CN=C=O)c1 ; O=C=NCc1cccc(Cn2c(=O)n(Cc3cccc(CN=C=O)c3)c(=O)n(Cc3cccc(CN=C=O)c3)c2=O)c1]
optionally, wherein the beta-aromatic isocyanate is selected from the group of xylylene diisocyanate, trimethylolpropane adducts of xylylene diisocyanate, tetramethylxylidene diisocyanate, isomers thereof, adducts thereof, and combinations thereof.

9. The composition according to claim 1, wherein the isocyanate component comprises at least two di- and/or poly-isocyanates selected from methylenediphenyl diisocyanate, polymeric methylenediphenyl isocyanate, and a trimethylol propane-adduct of xylylene diisocyanate, optionally, wherein the isocyanate component comprises methylenediphenyl isocyanate, polymeric methylenediphenyl isocyanate, and a trimethylol propane-adduct of xylylene diisocyanate in a weight ratio of from 1:2 to 1:1.75, optionally, wherein the isocyanate component comprises by weight 30 to 40%, optionally 34% a combination of methylenediphenyl isocyanate and polymeric methylenediphenyl isocyanate and from 60 to 70%, optionally 66% a trimethylol propane-adduct of xylylene diisocyanate.

10. The composition according to claim 1, wherein the chitosan is characterized by a weight average molecular weight of from about 100 kDa to about 80,000 kDa.

11. The composition according to claim 1, wherein the chitosan is characterized by a weight average molecular weight of from about 100 kDa to about 600 kDa.

12. The composition according to claim 1, wherein the chitosan is characterized by a weight average molecular weight from about 100 kDa to about 300 kDa.

13. The composition according to claim 1, wherein a ratio of the cross-linking agent to chitosan, based on weight is 79:21 to 10:90.

14. The composition according to claim 1, wherein a ratio of the cross-linking agent to chitosan, based on weight is 2:1 to 1:8.

15. The composition according to claim 1, wherein the core-shell encapsulate has a ratio of core to shell of at least 75:25 on the basis of weight.

16. The composition according to claim 1, wherein the capsules have a volume weighted median particle size of capsules of from about 5 microns to about 150 microns.

17. The composition according to claim 1, wherein said water-soluble carrier is selected from the group of:
a polyalkylene polymer of formula H—(C₂H₄O)ₓ—(CH(CH₃)CH₂O)_{y}—(C₂H₄O)_{z}—OH wherein x is from 50 to 300, y is from 20 to 100, and z is from 10 to 200;
a polyethylene glycol fatty acid ester of formula (C₂H₄O)_{q}—C(O)O—(CH₂)ᵣ—CH₃ wherein q is from 20 to 200 and r is from 10 to 30;
a polyethylene glycol fatty alcohol ether of formula HO—(C₂H₄O)ₛ—(CH₂)ₜ)—CH₃ wherein s is from 30 to 250 and t is from 10 to 30;
C8-C22 alkyl polyalkoxylate comprising more than 40 alkoxylate units;
polyethylene glycol having a weight average molecular weight from 2000 to 15000;
EO/PO/EO block copolymer;
PO/EO/PO block copolymer;
EO/PO block copolymer;
PO/EO block copolymer;
polypropylene glycol;
ethoxylated nonionic surfactant having a degree of ethoxylation greater than 30;
polyvinyl alcohol;
polyalkylene glycol having a weight average molecular weight from 2000 to 15000; and
mixtures thereof, preferably a polyethylene glycol having a weight average molecular weight of from about 2000 to about 15000, even more preferably a mixture of two polyethylene glycols having different molecular weights.

18. The composition according to claim 1, wherein said plurality of capsules is present at a level of about 0.1% to about 20%, by weight of the composition.

19. The composition according to claim 1, wherein said plurality of particles comprise individual particles, wherein said individual particles have a density less than about 1 g/cm³.

20. The composition according to claim 1, wherein said plurality of particles comprise individual particles, wherein said individual particles have a density of less than about optionally less than about 0.98 g/cm³.
